(19) United States
(12) Patent Application Publication
(10) Pub. No.: US 2026/0039789 A1
(43) Pub. Date: Feb. 5, 2026

(54) DECODING METHOD, ENCODING METHOD, DECODERS AND ENCODERS

(71) Applicant: GUANGDONG OPPO MOBILE TELECOMMUNICATIONS CORP., LTD., Dongguan (CN)

(72) Inventor: Zhihuang XIE, Dongguan (CN)

(73) Assignee: GUANGDONG OPPO MOBILE TELECOMMUNICATIONS CORP., LTD., Dongguan (CN)

(21) Appl. No.: 19/352,284

(22) Filed: Oct. 7, 2025

Related U.S. Application Data
(63) Continuation of application No. PCT/CN2023/086938, filed on Apr. 7, 2023.

(51) Int. Cl. H04N 19/105; H04N 19/176; H04N 19/70

(52) U.S. Cl. CPC H04N 19/105; H04N 19/176; H04N 19/70

(57) ABSTRACT

The embodiments of the present application belong to the technical field of encoding and decoding. Provided are a decoding method, an encoding method, decoders and encoders. The decoding method comprises: determining whether a current block uses an IBC-LIC mode; if it is determined that the current block uses the IBC-LIC mode, determining at least one template area used when performing illumination compensation on the current block, the at least one template area being used for determining a first model; on the basis of the IBC mode used by the current block, performing prediction on the current block to obtain a first prediction block of the current block; and, on the basis of the first model, performing illumination compensation on the first prediction block to obtain a second prediction block of the current block.

### CROSS-REFERENCE TO RELATED APPLICATIONS

This application is a continuation of International Application No. PCT/CN2023/086938, filed on Apr. 7, 2023, the disclosure of which is hereby incorporated by reference in its entirety.

### TECHNICAL FIELD

Embodiments of this application relate to the field of encoding and decoding technologies, and more specifically, to a decoding method, an encoding method, a decoder, and an encoder.

### BACKGROUND

Digital video compression technologies primarily compress huge amounts of digital image and video data, to facilitate transmission and storage. With explosive growth of internet videos and a growing demand of people for higher video resolution, although existing digital video compression standards can implement a video decompression technology, there is still a need to develop more advanced digital video decompression technologies, thereby improving decoding performance of a decoder.

### SUMMARY

Embodiments of this application provide a decoding method, an encoding method, a decoder, and an encoder, which can improve decoding performance of a decoder.

According to a first aspect, an embodiment of this application provides a decoding method, including:
determining whether an intra block copy local illuminance compensation IBC-LIC mode is used for a current block;
in a case that it is determined that the IBC-LIC mode is used for the current block, determining at least one template region for illuminance compensation, where the at least one template region is used to determine a first model;
predicting the current block based on an IBC mode used for the current block, to obtain a first predicted block of the current block; and
performing illuminance compensation on the first predicted block based on the first model, to obtain a second predicted block of the current block.

According to a second aspect, an embodiment of this application provides an encoding method, including:
performing illuminance compensation on a third predicted block based on a model determined according to a traversed template region, to obtain a first distortion cost set, where the third predicted block is a predicted block obtained by predicting a current block by using an intra block copy IBC advanced motion vector prediction AMVP mode;
performing illuminance compensation on a fourth predicted block based on an inherited template region, to obtain a second distortion cost set, where the fourth predicted block is a reference block in a merge candidate list obtained by predicting the current block based on an IBC merge mode; and determining a prediction mode used for the current block based on the first distortion cost set and the second distortion cost set.

According to a third aspect, an embodiment of this application provides a decoder, including:
a first determining unit, configured to determine whether an intra block copy local illuminance compensation IBC-LIC mode is used for a current block;
a second determining unit, configured to: in a case that it is determined that the IBC-LIC mode is used for the current block, determine at least one template region for illuminance compensation, where the at least one template region is used to determine a first model;
a prediction unit, configured to predict the current block based on an IBC mode used for the current block, to obtain a first predicted block of the current block; and
a compensation unit, configured to perform illuminance compensation on the first predicted block based on the first model, to obtain a second predicted block of the current block.

According to a fourth aspect, an embodiment of this application provides an encoder, including:
a first compensation unit, configured to perform illuminance compensation on a third predicted block based on a model determined according to a traversed template region, to obtain a first distortion cost set, where the third predicted block is a predicted block obtained by predicting a current block by using an intra block copy IBC advanced motion vector prediction AMVP mode;
a second compensation unit, configured to perform illuminance compensation on a fourth predicted block based on an inherited template region, to obtain a second distortion cost set, where the fourth predicted block is a reference block in a merge candidate list obtained by predicting the current block based on an IBC merge mode; and a determining unit, configured to determine a prediction mode used for the current block based on the first distortion cost set and the second distortion cost set.

According to a fifth aspect, an embodiment of this application provides a decoder, including:
a processor, adapted to execute computer instructions; and
a computer-readable storage medium, where the computer-readable storage medium stores computer instructions, and the computer instructions are adapted to be loaded by the processor to execute the decoding method according to the first aspect or implementations of the first aspect.

In an implementation, the processor includes one or more processors and the memory includes one or more memories.

In an implementation, the computer-readable storage medium may be integrated with the processor, or the computer-readable storage medium may be disposed separately from the processor.

According to a sixth aspect, an embodiment of this application provides an encoder, including:
a processor, adapted to execute computer instructions; and
a computer-readable storage medium, where the computer-readable storage medium stores computer instructions, and the computer instructions are adapted to be loaded by the processor to execute the encoding method according to the second aspect or implementations of the second aspect.

In an implementation, the processor includes one or more processors and the memory includes one or more memories.

In an implementation, the computer-readable storage medium may be integrated with the processor, or the computer-readable storage medium may be disposed separately from the processor.

According to a seventh aspect, an embodiment of this application provides a computer-readable storage medium. The computer-readable storage medium stores computer instructions, and when being read and executed by a processor of a computer device, the computer instructions cause the computer device to execute the decoding method according to the first aspect or the encoding method according to the second aspect.

According to an eighth aspect, an embodiment of this application provides a computer program product or a computer program, where the computer program product or the computer program includes computer instructions, and the computer instructions are stored in a computer-readable storage medium. A processor of a computer device reads the computer instructions from the computer-readable storage medium and executes the computer instructions, to cause the computer device to execute the decoding method according to the first aspect or the encoding method according to the second aspect.

According to a ninth aspect, an embodiment of this application provides a bitstream, where the bitstream is a bitstream related to the method according to the first aspect or a bitstream generated by using the method according to the second aspect.

### BRIEF DESCRIPTION OF DRAWINGS

FIG. 1 is a schematic block diagram of an encoding framework according to an embodiment of this application.

FIG. 2 is a schematic block diagram of a decoding framework according to an embodiment of this application.

FIG. 3 is an example of images with different brightness and a basically same texture according to an embodiment of this application.

FIG. 4 is an example of a modeling relationship between a reference frame and a current frame according to an embodiment of this application.

FIG. 5 is an example of CTU division and CU division according to an embodiment of this application.

FIG. 6 is an example of IBC according to an embodiment of this application.

FIG. 7 is an example of images with similar textures according to an embodiment of this application.

FIG. 8 is a schematic flowchart of a decoding method according to an embodiment of this application.

FIG. 9 is an example of at least one template region according to an embodiment of this application.

FIG. 10 is a schematic flowchart of an encoding method according to an embodiment of this application.

FIG. 11 is a schematic block diagram of a decoder according to an embodiment of this application.

FIG. 12 is a schematic block diagram of an encoder according to an embodiment of this application.

FIG. 13 is a schematic structural diagram of an electronic device according to an embodiment of this application.

### DESCRIPTION OF EMBODIMENTS

The following describes the technical solutions in embodiments of this application with reference to the accompanying drawings.

The solutions provided in embodiments of this application may be applied to the field of digital video coding technologies, which, for example, includes but is not limited to: the field of image encoding and decoding, the field of video encoding and decoding, the field of hardware video encoding and decoding, the field of dedicated circuit video encoding and decoding, and the field of real-time video encoding and decoding. In addition, the solutions provided in embodiments of this application may be combined with an audio video coding standard (Audio Video coding Standard, AVS), a second-generation AVS standard (AVS2), or a third-generation AVS standard (AVS3), which, for example, includes but is not limited to an H.264/audio video coding (Audio Video coding, AVC) standard, an H.265/high efficiency video coding (High Efficiency Video Coding, HEVC) standard, and an H.266/versatile video coding (Versatile Video Coding, VVC) standard. In addition, the solutions provided in embodiments of this application may be used to perform lossy compression or lossless compression on an image. The lossless compression may be visually lossless compression (visually lossless compression) or mathematically lossless compression (mathematically lossless compression).

Video encoding and decoding standards all use a block-based hybrid coding framework. Each frame in a video is partitioned into square largest coding units (LCU) or coding tree units (CTU) of a same size (for example, 128×128 or 64×64). Each largest coding unit or coding tree unit may be partitioned into rectangular coding units (CU) according to rules. A coding unit may be classified into a prediction unit (PU), a transform unit (TU), and the like. The hybrid encoding framework includes a prediction module, a transform module, a quantization module, an entropy encoding module, an in-loop filtering module, and the like. The prediction module includes intra prediction and inter prediction. Inter prediction includes motion estimation and motion compensation. Due to strong correlation between adjacent samples in a video frame, spatial redundancy between adjacent samples is eliminated by using an intra prediction method in a video encoding and decoding technology. In intra prediction, sample information in a current block obtained by partitioning is predicted by referring to only information about a same frame of image. Due to strong similarity between adjacent frames in a video, spatial redundancy between adjacent frames is eliminated by using an inter prediction method in a video encoding and decoding technology, thereby improving encoding efficiency. In inter prediction, reference may be made to image information of different frames, and motion vector information that best matches a current block obtained by partitioning is searched through motion estimation. In transform, a predicted image block is converted into a frequency domain, and energy is redistributed. In combination with quantization, information insensitive to human eyes can be removed, to eliminate visual redundancy. In entropy encoding, character redundancy may be eliminated according to a current context model and probability information of a binary bitstream.

A basic procedure of a video codec is as follows:

At an encoding end, a frame of image is divided into blocks. Intra prediction or inter prediction is performed on the current block, to generate a predicted block of the current block. The predicted block is subtracted from an original image block of the current block, to obtain a residual block. Then, the residual block is transformed and quantized, to obtain a quantized coefficient matrix. Then, the quantized coefficient matrix is entropy encoded and output into a bitstream. At a decoding end, intra prediction or inter prediction is performed on a current block, to generate a predicted block of the current block. On the other hand, a bitstream is parsed, to obtain a quantized coefficient matrix. Then, inverse quantization and inverse transform are performed on the quantized coefficient matrix, to obtain a residual block. Then, the predicted block is added with the residual block, to obtain a reconstructed block. Reconstructed blocks form a reconstructed image, and in-loop filtering is performed on the reconstructed image on a per-image basis or on a per-block basis, to obtain a decoded image. The encoding end needs to perform operations similar to the operations of the decoding end, to obtain a decoded image. The decoded image may be used as a reference frame for performing inter prediction on a subsequent frame. Block partitioning information, mode information or parameter information of prediction, transform, quantization, entropy encoding, in-loop filtering and the like determined by the encoding end may be output into the bitstream if necessary. The decoding end determines, by parsing or analysis based on existing information, the block partitioning information, mode information or parameter information of prediction, transform, quantization, entropy encoding, in-loop filtering, and the like that is the same as the information at the encoding end. This ensures that the decoded image obtained by the encoding end is the same as the decoded image obtained by the decoding end. The decoded image obtained by the encoding end is generally referred to as a reconstructed image. In prediction, the current block may be partitioned into prediction units. In transform, the current block may be partitioned into transform units. Partitioning of the prediction units may be different from partitioning of the transform units. The foregoing provides a basic procedure of a video codec in a block-based hybrid coding framework. With development of technologies, some modules of the framework or some steps in the procedure may be optimized, which is not specifically limited in this application.

The current block may be a current coding unit (CU), a current prediction unit (PU), or the like.

This application is applicable to a basic procedure of a video codec in the block-based hybrid coding framework.

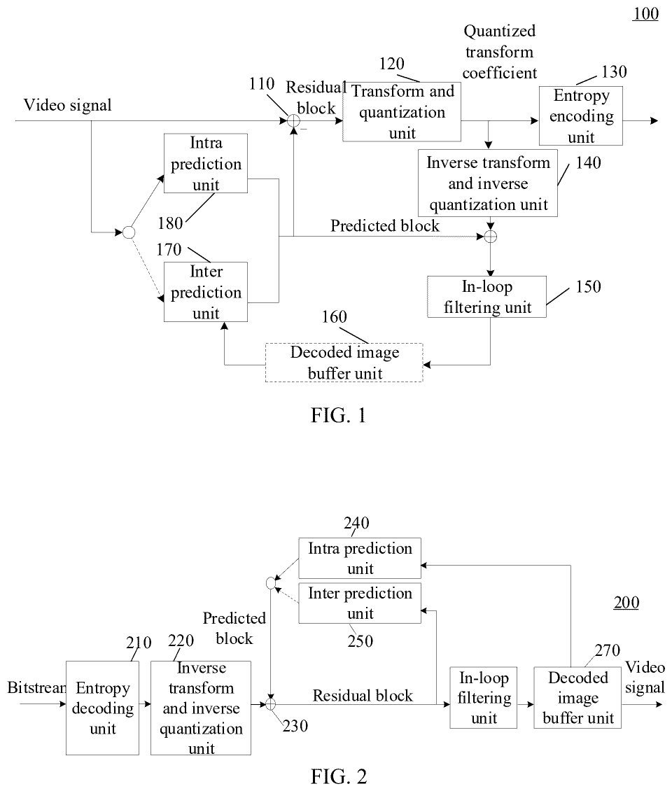

FIG. 1 is a schematic block diagram of an encoding framework 100 according to an embodiment of this application.

As shown in FIG. 1, the encoding framework 100 may include an intra prediction unit 180, an inter prediction unit 170, a residual unit 110, a transform and quantization unit 120, an entropy encoding unit 130, an inverse transform and inverse quantization unit 140, and an in-loop filtering unit 150. Optionally, the encoding framework 100 may further include a decoded image buffer unit 160. The encoding framework 100 may also be referred to as a hybrid encoding framework.

The intra prediction unit 180 or the inter prediction unit 170 may predict a to-be-encoded image block, to output a predicted block. The residual unit 110 may calculate, based on the predicted block and the to-be-encoded image block, a residual block, that is, a difference between the predicted block and the to-be-encoded image block. The transform and quantization unit 120 is configured to execute operations such as transform and quantization on the residual block, to remove information insensitive to human eyes, thereby eliminating visual redundancy. Optionally, the residual block that has not undergone transform and quantization by the transform and quantization unit 120 may be referred to as a time domain residual block, and the time domain residual block obtained after the transform and quantization unit 120 performs transform and quantization may be referred to as a frequency residual block or a frequency domain residual block. After receiving a quantized transform coefficient output by the transform and quantization unit 120, the entropy encoding unit 130 may output a bitstream based on the quantized transform coefficient. For example, the entropy encoding unit 130 may eliminate character redundancy according to a target context model and probability information of a binary bitstream. For example, the entropy encoding unit 130 may be configured for context-adaptive binary arithmetic coding (CABAC). The entropy encoding unit 130 may also be referred to as a header information encoding unit. Optionally, in this application, the to-be-encoded image block may also be referred to as an original image block or a target image block; the predicted block may also be referred to as a predicted image block, or an image prediction block, or a predicted signal, or predicted information; and a reconstructed block may also be referred to as a reconstructed image block, or an image reconstruction block, or a reconstructed signal, or reconstructed information. In addition, for an encoding end, the to-be-encoded image block may also be referred to as a coding block or a coding image block, and for a decoding end, the to-be-encoded image block may also be referred to as a decoding block or a decoding image block. The to-be-encoded image block may be a CTU or a CU.

The encoding framework 100 calculates a residual of the predicted block and the to-be-encoded image block, to obtain the residual block, performs operations such as transform and quantization on the residual block, and transmits the residual block to the decoding end. Correspondingly, after receiving and parsing the bitstream, the decoding end performs steps such as inverse transform and inverse quantization, to obtain the residual block, and adds the residual block to the predicted block obtained by prediction, to obtain a reconstructed block.

It should be noted that the inverse transform and inverse quantization unit 140, the in-loop filtering unit 150, and the decoded image buffer unit 160 in the encoding framework 100 may be configured to form a decoder. That is, the intra prediction unit 180 or the inter prediction unit 170 may predict the to-be-encoded image block based on an existing reconstructed block, thereby ensuring consistent understandings of a reference frame between the encoding end and the decoding end. In other words, an encoder may copy a processing loop of the decoder, to generate a same prediction as the decoding end. Specifically, the inverse transform and inverse quantization unit 140 performs inverse transform and inverse quantization on a quantized transform coefficient, to reproduce an approximate residual block at the decoding end. The approximate residual block and the predicted block may be added and then processed by the in-loop filtering unit 150, to smoothly eliminate an impact of blocking artifacts caused by block processing and quantization. An image block output by the in-loop filtering unit 150 may be stored in the decoded image buffer unit 160 for subsequent image prediction.

It should be understood that FIG. 1 is merely an example of this application, and shall not be construed as a limitation on this application.

For example, the in-loop filtering unit 150 in the encoding framework 100 may include a deblocking filter (DBF) and a sample adaptive offset filter (SAO). The DBF is configured to remove blocking artifacts and the SAO is configured to remove ringing artifacts. In other embodiments of this application, the encoding framework 100 may use an in-loop filtering algorithm based on a neural network, to improve video compression efficiency. In other words, the encoding framework 100 may be a hybrid video encoding framework based on a deep learning neural network. In one implementation, based on the deblocking filter and the sample adaptive offset filter, a model based on a convolutional neural network may be used to calculate a sample filtering result. A network structure of the in-loop filtering unit 150 for a luma component may be the same as or different from a network structure of the in-loop filtering unit 150 for a chroma component. Considering that the luma component includes more visual information, the luma component may also be used to guide filtering of the chroma component, thereby improving reconstruction quality of the chroma component.

FIG. 2 is a schematic block diagram of a decoding framework 200 according to an embodiment of this application.

As shown in FIG. 2, the decoding framework 200 may include an entropy decoding unit 210, an inverse transform and inverse quantization unit 220, a residual unit 230, an intra prediction unit 240, an inter prediction unit 250, an in-loop filtering unit 260, and a decoded image buffer unit 270.

After receiving and parsing a bitstream, the entropy decoding unit 210 acquires a predicted block and a frequency domain residual block. The inverse transform and inverse quantization unit 220 performs steps such as inverse transform and inverse quantization on the frequency domain residual block, to acquire a time domain residual block. The residual unit 230 adds the predicted block obtained after the intra prediction unit 240 or the inter prediction unit 250 performs prediction to the time domain residual block obtained after the inverse transform and inverse quantization unit 220 performs the inverse transform and the inverse quantization, to obtain a reconstructed block. For example, the intra prediction unit 240 or the inter prediction unit 250 may acquire the predicted block by decoding header information of the bitstream.

The international video coding standard formulation organization JVET has set up a team for research beyond H.266/VVC coding model and has named the model, that is, platform test software, as ECM. The ECM is introduced with more latest and efficient compression algorithms on the basis of VTM10.0, and has exceeded VVC in encoding performance by about 13%. The ECM not only expands dimensions of a coding unit with a specific resolution but also integrates many intra prediction technologies and inter prediction technologies. The following describes related technologies in this application.

### (1) Illuminance Compensation Technology

In a real-world natural video, there is usually a change in illuminance intensity of video content, such as a decrease in illuminance intensity as time elapses, blocking of a dark cloud, or a change in flashlight intensity of a camera. A difference between the video content and a previous/subsequent frame of image mainly lie in strength of a direct current component of an image, and texture information in the content basically does not change. However, due to an impact of a relatively large value of the direct current component, motion search and motion compensation of an inter prediction technology cannot effectively predict the content, and a relatively large amount of residual information is prone to be encoded. A local illuminance compensation (Local Illuminance Compensation, LIC) technology can well remove the direct current redundancy information, accurately predict a brightness change, and make corresponding compensation, thereby reducing residual information and improving encoding efficiency. The local illuminance compensation technology is referred to as illuminance compensation hereinafter.

The latest video encoding and decoding standard H.266/VVC has been finalized. The joint video experts team JVET proposes to explore a video encoding and decoding standard that exceeds VVC in encoding performance on the basis of VVC and creates an exploration experiment EE2 for the purpose of exploring beyond VVC. Platform reference software used in the exploration experiment is based on VTM11.0. New algorithms will be integrated into the software, and a branch is changed to ECM. In addition, a plurality of expert discussion groups are set up for ECM. The latest ECM reference software version 8.0 already exceeds VVC in encoding performance by more than 19%. As the latest standard, VVC exceeds the previous-generation video encoding and decoding standard H.265/HEVC in encoding performance by only about 27%. Therefore, it is imaginable that exploration and research of next-generation video encoding and decoding standards may be started based on ECMs in the near future.

At the initial stage of ECM proposal, reference software has integrated encoding tools that are not included in VVC. These encoding tools provide different ECM encoding scenarios with efficient encoding performance and powerful processing capabilities, including LIC. The following briefly introduces LIC in a current ECM.

The illuminance compensation technology is an inter coding technology. In an inter coding process, a current coding unit acquires corresponding reference blocks according to MVs (motion vector information), where the reference blocks usually come from different coding frames, or in other words, reference coding units do not belong to a current image. Different frames of image change greatly or slightly in some specific scenarios, and the illuminance compensation technology is extremely effective for processing some of these changes.

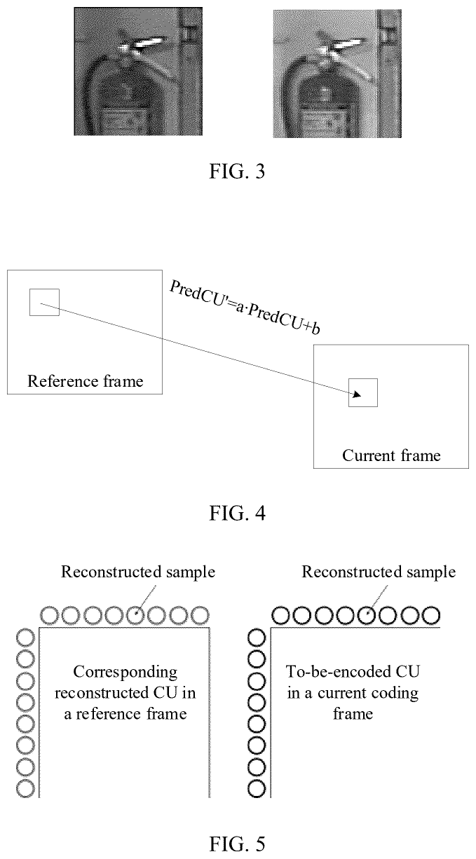

FIG. 3 is an example of images with different brightness and a basically same texture according to an embodiment of this application.

As shown in FIG. 3, the left part and right part have basically the same as texture information but have different brightness. The image on the right is illuminated by flashlight of a camera and therefore seems quite bright. The image on the left is illuminated by natural light. This difference between the two images causes a huge impact in video coding. It is assumed that the right block is used as a reference coding unit for the left block, and texture information of the left block is the same as texture information of the right block. Therefore, a difference between the two blocks in texture details is very small, but an overall residual between the two blocks is very large. All samples in the image on the right have an offset due to flashlight, and a residual between the images includes this offset. In a case that this part of the residual is directly transformed, quantized and written into a bitstream, overheads are huge.

An illuminance compensation technology in ECM reference software eliminates, through linear fitting, the impact caused by flashlight or an illuminance change, for example, so that an overall prediction effect is better.

Major parts of the illuminance compensation technology are as follows:
Correlation of a change between a prediction sample in a coding unit and a reference sample is fitted by using correlation between a reconstructed sample adjacent to a reference coding unit and a reconstructed sample adjacent to a current coding unit. Because reconstructed samples in upper and left regions adjacent to the current coding unit can be acquired if any, and reconstructed samples in upper and left regions adjacent to the reference coding unit in a reference image can also be acquired, a corresponding fitting model can be obtained by modeling reconstructed samples of a current frame and reconstructed samples of the reference image.

In a modeling process, illuminance compensation of an ECM is performed by linear fitting, and the model is simplified as including a scaling parameter a and a bias parameter b to fit an illuminance change between the current frame and the reference frame. A change relationship represented by model parameters is as follows:

$${Pred}^{′} ( x , y ) = a \cdot Pred ( x , y ) + b .$$

Herein, Pred(x, y) is a predicted block that has not undergone illuminance compensation, Pred′(x, y) is a predicted block obtained by illuminance compensation, a is the scaling parameter in the illuminance compensation model, and b is the bias parameter in the illuminance compensation model. Both a and b in the formula need to be calculated by using image information of the current frame and image information of the reference frame and are obtained by modeling reconstructed samples spatially adjacent to a current block and samples spatially adjacent to a reconstructed block in the corresponding reference frame. A derivation formula is as follows:

$${Curr\_Rec}_{neigh} = a \cdot {Ref\_Rec}_{neigh} + b .$$

Herein, Curr_Rec_{neigh} is a reconstructed image of the current frame, and Ref_Rec_{neigh} is a reconstructed image of the reference frame. In a digital video encoding and decoding process, as shown in FIG. 4, illuminance difference correction may be performed on a coding block of the current frame by using an illuminance compensation model, to obtain a compensated predicted block.

In addition, the scaling parameter a and the bias parameter b need to be modeled and solved according to correlation between reconstructed samples in a region adjacent to a coding unit of the current frame and reconstructed samples at corresponding positions in the reference frame and by using reconstructed samples in a region adjacent to a corresponding reconstructed block in the reference frame and reconstructed samples in a region adjacent to the coding block in the current frame.

FIG. 5 is an example of CTU division and CU division according to an embodiment of this application.

As shown in FIG. 5, a linear relationship is solved by modeling nearest reconstructed samples (Reconstructed pixels) of corresponding CUs in two frames, to obtain a scaling parameter a and a bias parameter b. Then, the linear relationship is applied to a corresponding reconstructed CU (Reference picture CU) in a reference frame, to obtain a predicted block of a to-be-encoded CU (Current picture CU) in a current coding frame.

A specific modeling process is as follows:

An illuminance compensation model in an ECM is a linear model, and parameters of the model include a scaling factor a and a bias parameter b, which are obtained by using a least square error. A quantity of reconstructed samples is set according to a width and a height of a current coding unit. In a case that any one of the width or the height of the current coding unit is equal to 4, four reconstructed samples are obtained from upper reconstructed samples adjacent to the coding unit and four reconstructed samples are obtained from left reconstructed samples adjacent to the coding unit. For example, the width of the current coding unit is 16 and the height of the current coding unit is 4. In this case, four reconstructed samples are obtained from the left reconstructed samples adjacent to the current coding unit, and four reconstructed samples are obtained from the upper reconstructed samples adjacent to the current coding unit by using a step of 3. In a case that neither the width nor the height of the current coding unit is equal to 4, reconstructed samples whose quantity is a 2-based logarithm of a smaller side length are acquired from the upper and left reconstructed samples adjacent to the current coding unit.

The parameters of the model are calculated after the upper and left reconstructed samples are acquired. It is assumed that an acquired reconstructed sample of the reference frame is denoted as x, and an acquired reconstructed sample of the current frame is denoted as y. In this case, a sum of reconstructed samples of the reference frame is denoted as sumX, and a sum of reconstructed samples of the current frame is denoted as sumY; a sum of squares of the reconstructed samples of the reference frame is denoted as sumXX, and a sum of products of the reconstructed samples of the reference frame and the reconstructed samples of the current frame is denoted as sumXY. In this case, the parameters are calculated as follows:

$$a = ( sumXY - sumXsumY ) / ( sumXX - sumXsumX )$$

$$b = sumY - a * sumX$$

Herein, sumXsumY is sumX times sumY. Some shift operations in a calculation process of ECM reference software are all simplified processes and are not described in detail herein. After the parameters of the linear model are obtained, linear transform is performed on a predicted block obtained by motion compensation, to obtain a final predicted block.

In a case that the reconstructed samples used to calculate the parameters of the linear model belong to an inter prediction block, an interpolation operation needs to be performed.

The illuminance compensation technology in the ECM may be applied to a common inter prediction mode, a merge prediction mode, and a sub-block mode. The common inter prediction mode is an inter mode, the merge prediction mode is a merge mode, and the sub-block mode is an affine mode. The illuminance compensation technology applies to only a single-frame prediction mode and is disabled for a multi-frame bidirectional reference mode.

In addition, the illuminance compensation technology in the ECM is coupled to an adopted technology. For a current coding unit, the illuminance compensation technology is not used together with a bi-directional optical flow (BDOF) technology, a symmetric motion vector difference (SMVD) technology, or the like.

### (2) Application of the Illuminance Compensation Technology in an Intra Block Copy (Intra Block Copy, IBC) Technology

Generally, the illuminance compensation technology is applied to inter prediction, and a technology in intra prediction, that is, an IBC technology, is similar to inter prediction. As implied in the name of IBC, a current frame is searched for a block that matches or is similar to a current coding block, and the block is copied as a predicted block of the current coding block. This is an intra prediction technology dedicated to screen content encoding.

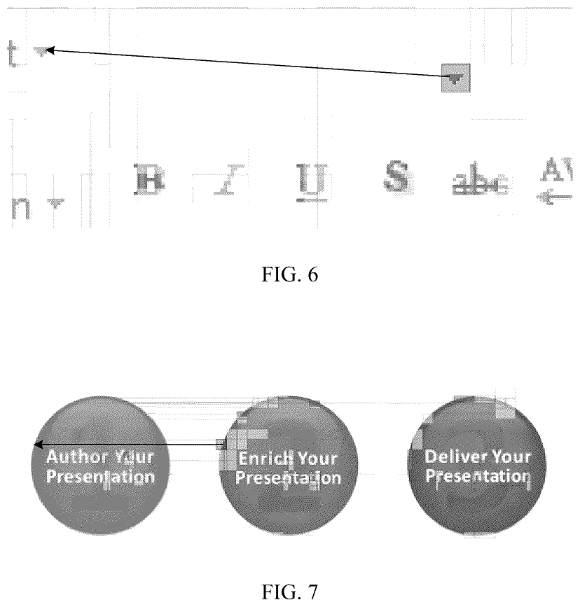

FIG. 6 is an example of IBC according to an embodiment of this application.

As shown in FIG. 6, there is a graphic texture shaped like an inverted triangle in a coding block. In a case that a conventional intra prediction technology is used to encode the current coding block, a large quantity of bits need to be consumed to encode residual information. After an intra block copy technology is used, a specified range in a current frame is searched, so as to find a similar or same part in the upper left corner. Through distortion cost calculation or hash value matching, a found reconstructed block is determined and copied as a predicted block of the current coding block. It can be learned that this prediction technology is much more efficient than a conventional intra coding technology. In some cases, even an exactly same predicted block can be found, so that residual information does not need to be encoded, thereby greatly reducing bit overheads. In addition, a solid line with an arrow represents a block vector BV of the current coding block. At a decoding end, a reconstructed block that matches the current coding block is found by using the BV and used as a predicted block of the current coding block.

Same as inter prediction, IBC has two modes. One is an advanced motion vector prediction (Advanced Motion Vector Prediction, AMVP) mode, and the other is a skip or merge mode, that is, a merge mode.

In the AMVP mode, IBC needs to transmit an index to indicate which block is used for block vector prediction (Block Vector Prediction, BVP) and encode a block vector error (Block Vector Difference, BVD).

In the skip/merge mode, IBC needs to transmit an index to indicate a used BV information.

Same as inter prediction, in some application scenarios, even if coding blocks have same texture information, the coding blocks may have a color difference. In a natural sequence, a most common scenario is an illuminance change. For example, a camera fixedly shoots a building, and video content of the building shot in the morning is the same as video content of the building shot in the afternoon. However, illuminance intensity changes. Therefore, even if a decoded reconstructed frame is used for reference in inter prediction, video content cannot be completely represented. Due to different illuminance intensity, overall average values of video content are different, and a large quantity of residual bitstreams are required for encoding. This problem is well resolved by an illuminance compensation technology. By establishing a linear model, reference content and current content are converted, to adapt to different illuminance intensity without changing texture content.

In short, a similar problem also exists in screen content encoding. Even if coding blocks have same content, a color difference or another problem may cause relatively low encoding efficiency of an intra block copy technology, and even a similar coding block cannot be found. For example, for four sub-images with same image content and a same texture but different colors, the block copy technology has a low efficiency or even cannot find a matched reconstructed image content due to a relatively large color difference.

As the inter-frame LIC technology, the IBC-LIC technology establishes a linear relationship between a reference block and a coding block and converts the reference block to be used as a predicted block of a current coding unit. This process is the same as the foregoing inter-frame LIC. In the AMVP mode, IBC needs a flag bit to indicate whether the LIC technology is used. In the merge mode, the LIC technology is enabled and disabled through inheritance. For example, for four sub-images with same image content and a same texture but different colors, after the IBC-LIC technology is enabled, the IBC-LIC technology can be used to copy content of a previous reconstructed sub-image for more and more coding blocks starting from the second sub-image.

It can be learned from the foregoing analysis that the IBC-LIC technology can provide considerable performance in an application scenario of screen content encoding. A calculation process of the IBC-LIC technology is the same as a calculation process of the inter-frame LIC technology. In terms of both software and hardware, complexity is acceptable and cost-effectiveness is high.

However, IBC-LIC uses inter-frame LIC of using reference samples and reconstructed samples in both upper and left template regions as inputs for modeling. This may not exactly match a scenario of screen content encoding. Generally, in a natural sequence, illuminance changes should be the same for content in a current frame. In a screen content scenario, content changes at a sample level, which is relatively sharp. It is possible that the upper template region can reflect a linear relationship between a current coding block and a reference block, but the left template region may differ greatly from the current coding block. This may have a negative impact on establishing a linear model.

FIG. 7 is an example of images with similar textures according to an embodiment of this application.

As shown in FIG. 7, it is assumed that the sub-image in the middle is a sub-image with a blue background, the sub-image on the left is a sub-image with an orange background, and the sub-image on the right is a sub-image with a green background. For the sub-image in the middle, reference may be made to the sub-image on the left. For a coding block on a left edge of the sub-image in the middle, reference may be made to a same position in the sub-image on the left. Due to a color difference, linear transform of IBC-LIC needs to be performed. As described above, in a case that both the upper template region and the left template region are used to calculate parameters of a model, accuracy of the model is affected because the left region includes entirely white and flat content and cannot provide useful information.

In view of this, embodiments of this application provide a decoding method, an encoding method, a decoder, and an encoder.

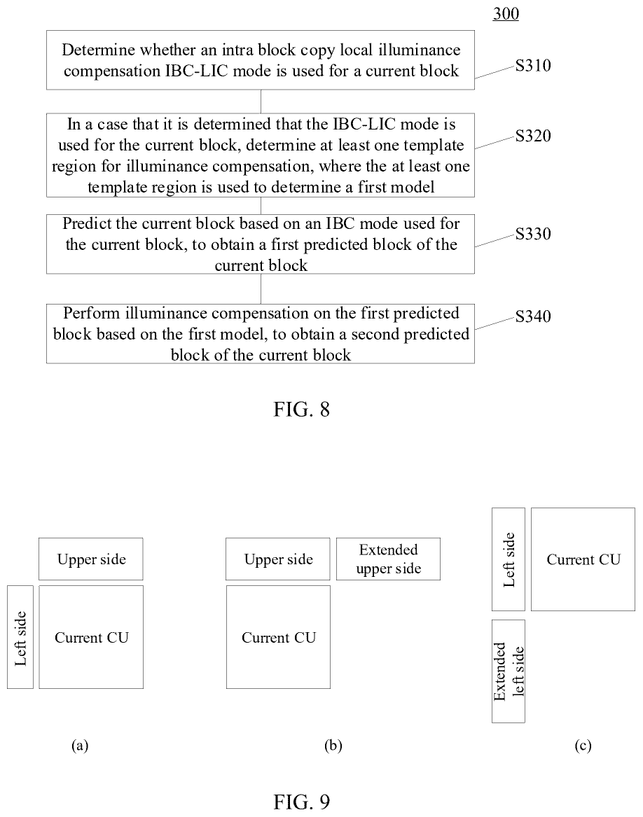

FIG. 8 is a schematic flowchart of a decoding method 300 according to an embodiment of this application. It should be understood that the decoding method 300 may be executed by a decoder. For example, the method may be applied to the decoding framework 200 shown in FIG. 2 or another similar decoding framework. For ease of description, the following uses a decoder as an example for description.

As shown in FIG. 8, the decoding method 300 may include some or all of the following:

S310: The decoder determines whether an intra block copy local illuminance compensation (Intra Block Copy Local Illuminance Compensation, IBC-LIC) mode is used for a current block.

It should be noted that the IBC-LIC mode refers to performing, by using an LIC technology, illuminance compensation on a predicted block obtained by predicting a current block by using IBC. In another alternative embodiment, the IBC-LIC mode may also be referred to as other terms that have similar meanings, such as a prediction mode corresponding to IBC and LIC, and a compensation mode corresponding to IBC and LIC. This is not limited in this application.

S320: In a case that it is determined that the IBC-LIC mode is used for the current block, the decoder determines at least one template region for illuminance compensation, where the at least one template region is used to determine a first model.

It should be noted that the at least one template region is intended to describe a template region used when the decoder calculates a linear model (that is, the first model) or when the decoder calculates model parameters of the first model. In another alternative embodiment, the at least one template region may also be referred to as an LIC mode or a linear model calculation mode. This is not specifically limited in this application.

It should be noted that, since different template regions may correspond to different prediction modes in the IBC-LIC mode, in another alternative embodiment, “determining at least one template region for illuminance compensation” may also be understood as or is equivalent to “determining a prediction mode that is used for the current block and that belongs to the IBC-LIC mode”. Optionally, the prediction mode that is used for the current block and that belongs to the IBC-LIC mode may be any one of the following modes: IBC-LIC-TL, IBC-LIC-T, or IBC-LIC-L. In IBC-LIC-TL, both an upper template region and a left template region are used. In IBC-LIC-T, only an upper template region is used. In IBC-LIC-L, only a left template region is used.

S330: The decoder predicts the current block based on an IBC mode used for the current block, to obtain a first predicted block of the current block.

The IBC mode used for the current block may be an IBC advanced motion vector prediction (Advanced Motion Vector Prediction, AMVP) mode or an IBC merge mode.

S340: The decoder performs illuminance compensation on the first predicted block based on the first model, to obtain a second predicted block of the current block.

Exemplarily, after the decoder obtains the first predicted block by predicting the current block based on the IBC mode used for the current block, the decoder acquires at least one template region of the first predicted block and at least one template region of the current block, and calculates the model parameters of the first model based on the at least one template region of the first predicted block and the at least one template region of the current block. Then, the decoder may perform illuminance compensation on the first predicted block based on the model parameters of the first model, to obtain the second predicted block.

It should be noted that the model parameters of the first model, such as the scaling parameter a and the bias parameter b mentioned above, may be calculated by referring to the foregoing formulas for calculating the scaling parameter a and the bias parameter b. Similarly, when performing illuminance compensation on the first predicted block based on the first model, the decoder may further apply the linear relationship to the first predicted block, to obtain the second predicted block. For a specific compensation method, reference may be made to content related to FIG. 5. To avoid repetition, details are not described herein again.

In the embodiments, in a case that it is determined that an IBC-LIC mode is used for a current block, at least one template region for illuminance compensation is determined, where the at least one template region is used to determine a first model; the current block is predicted based on an IBC mode used for the current block, to obtain a first predicted block of the current block; and illuminance compensation is performed on the first predicted block based on the first model, to obtain a second predicted block of the current block. That is, when the IBC-LIC mode is used for the current block, a decoder needs to determine a proper template region and the first model, to perform illuminance compensation on the first predicted block based on the first model, thereby avoiding using a unified template region to perform illuminance compensation, and improving decoding performance of the decoder.

The following describes beneficial effects of the solutions provided in this application with reference to a test result shown in Table 1.

Table 1 shows a test result obtained by integrating a decoding method provided in this application into latest ECM8.0.

TABLE 1

All intra Main10
Over ECM8.0

| | Y | U | V | EncT | DecT |
|---|---|---|---|---|---|
| Class A1 | 0.00% | 0.00% | 0.00% | 100% | 100% |
| Class A2 | 0.00% | 0.00% | 0.00% | 100% | 100% |
| Class B | 0.00% | 0.00% | 0.00% | 100% | 100% |
| Class C | 0.00% | 0.00% | 0.00% | 100% | 100% |
| Class E | 0.00% | 0.00% | 0.00% | 100% | 100% |
| Overall | 0.00% | 0.00% | 0.00% | 100% | 100% |
| Class D | 0.00% | 0.00% | 0.00% | 100% | 100% |
| Class F | −0.36% | −0.25% | −0.48% | 105% | 103% |
| Class TGM | −0.02% | −0.02% | −0.01% | 103% | 101% |

Note:
A negative number represents a performance gain, i.e., a quantity of bits decreases under same quality.

As shown in Table 1, since the solutions provided in this application are applied in a scenario of screen content encoding, a common test condition for screen content encoding is used in testing, that is, the technical solutions provided in this application are not applied to class A1 to class E. Therefore, there is no change in encoding performance and no fluctuation in an encoding time from class Al to class E. Class F and class TGM are sequence classes dedicated to screen content encoding. In terms of simulation results, this technology improves encoding performance of class F by 0.36%. It should be noted that, due to a server load, theoretically, a decoding time basically does not increase even if an encoding time or a decoding time fluctuates slightly.

In some embodiments, the at least one template region includes at least one of the following:
an upper template region; or
a left template region.

In the embodiments, the at least one template region may be only the upper template region, or may be only the left template region, or may include both the upper template region and the left template region. That is, illuminance compensation for only the upper template region and illuminance compensation for only the left template region are proposed. In other words, a solution of calculating parameters of a linear model by using only a template region on only one side is proposed, thereby improving flexibility of illuminance compensation and enhancing a compensation effect.

That the at least one template region is the upper template region is used as an example. After the decoder predicts the current block based on the IBC mode used for the current block to obtain the first predicted block, the decoder acquires an upper template region of the first predicted block and an upper template region of the current block, and calculates the model parameters of the first model based on the upper template region of the first predicted block and the upper template region of the current block. Then, the decoder may perform illuminance compensation on the first predicted block based on the model parameters of the first model, to obtain the second predicted block.

Exemplarily, the upper template region includes but is not limited to at least one of the following: a template region directly above, a template region on the upper left, or a template region on the upper right.

For example, the upper template region of the current block is used as an example. The upper template region of the current block may be a template region directly above the current block, or may be a template region directly above the current block and a template region on the upper left of the current block, or may be a template region directly above the current block and a template region on the upper right of the current block, or may even include a template region on the upper left of the current block, a template region directly above the current block, and a template region on the upper right of the current block. The template region directly above the current block may refer to a template region that is above the current block and that has a left boundary aligned with a left boundary of the current block and a right boundary aligned with a right boundary of the current block. The template region on the upper right of the current block may refer to a template region that is above the current block and that has a left boundary aligned with the right boundary of the current block. The template region on the upper left of the current block may refer to a template region that is above the current block and that has a right boundary aligned with the left boundary of the current block.

Exemplarily, the left template region includes but is not limited to at least one of the following: a template region on the left, a template region on the upper left, or a template region on the lower left.

The left template region of the current block is used as an example. The left template region of the current block may be a template region on the left of the current block, or may be a template region on the left of the current block and a template region on the upper left of the current block, or may be a template region on the left of the current block and a template region on the lower left of the current block, or may even include a template region on the left of the current block, a template region on the upper left of the current block, and a template region on the lower left of the current block. The template region on the left of the current block may refer to a template region that is on the left of the current block and that has an upper boundary aligned with an upper boundary of the current block and a lower boundary aligned with a lower boundary of the current block. The template region on the upper left of the current block may refer to a template region that is on the left of the current block and that has a lower boundary aligned with the upper boundary of the current block. The template region on the lower left of the current block may refer to a template region that is on the left of the current block and that has an upper boundary aligned with the lower boundary of the current block.

In some embodiments, a sampling step used when the at least one template region is the upper template region or the left template region is less than a sampling step used when the at least one template region includes the upper template region and the left template region, where a sample obtained from the at least one template region according to the sampling step is used to determine the first model.

Exemplarily, a difference between the sampling step used when the at least one template region includes the upper template region and the left template region and the sampling step used when the at least one template region is the upper template region or the left template region is a preset value, where the preset value is any value greater than 0. For example, the difference between the sampling step used when the at least one template region includes the upper template region and the left template region and the sampling step used when the at least one template region is the upper template region or the left template region is two sampling points or another quantity of sampling points.

Exemplarily, the sampling step used when the at least one template region includes the upper template region and the left template region is an integer multiple of the sampling step used when the at least one template region is the upper template region or the left template region. For example, the sampling step used when the at least one template region includes the upper template region and the left template region is two times or another multiple of the sampling step used when the at least one template region is the upper template region or the left template region.

A quantity of samples in the upper template region and the left template region used to calculate the model parameters is generally greater than a quantity of samples in only the upper template region used to calculate the model parameters. Correspondingly, accuracy of the model whose model parameters are calculated by using the upper template region and the left template region is also higher than accuracy of the model whose model parameters are calculated by using only the upper template region. In embodiments, a quantity of samples that participate in calculation of model parameters is increased by reducing a sampling step, or even all available samples in a template region are selected to calculate parameters of a linear model. Therefore, accuracy of a model whose model parameters are calculated by using only the upper template region or only the left template region can be improved.

In some embodiments, a quantity of sample rows of the upper template region used when the at least one template region is the upper template region is greater than a quantity of sample rows of the upper template region used when the at least one template region includes the upper template region and the left template region; and/or, a quantity of sample columns of the upper template region used when the at least one template region is the upper template region is greater than a quantity of sample columns of the upper template region used when the at least one template region includes the upper template region and the left template region.

Exemplarily, the quantity of the sample rows of the upper template region used when the at least one template region is the upper template region is greater than the quantity of the sample rows of the upper template region used when the at least one template region includes the upper template region and the left template region by N (N is a positive integer). Alternatively, the quantity of the sample rows of the upper template region used when the at least one template region is the upper template region is an integer multiple of the quantity of the sample rows of the upper template region used when the at least one template region includes the upper template region and the left template region. For example, the quantity of the sample rows of the upper template region used when the at least one template region is the upper template region is two times or another multiple of the quantity of the sample rows of the upper template region used when the at least one template region includes the upper template region and the left template region.

Exemplarily, the quantity of the sample columns of the upper template region used when the at least one template region is the upper template region is greater than the quantity of the sample columns of the upper template region used when the at least one template region includes the upper template region and the left template region by M (M is a positive integer). Alternatively, the quantity of the sample columns of the upper template region used when the at least one template region is the upper template region is an integer multiple of the quantity of the sample columns of the upper template region used when the at least one template region includes the upper template region and the left template region. For example, the quantity of the sample columns of the upper template region used when the at least one template region is the upper template region is two times or another multiple of the quantity of the sample columns of the upper template region used when the at least one template region includes the upper template region and the left template region.

A quantity of samples in the upper template region and the left template region used to calculate the model parameters is generally greater than a quantity of samples in only the upper template region used to calculate the model parameters. Correspondingly, accuracy of the model whose model parameters are calculated by using the upper template region and the left template region is also higher than accuracy of the model whose model parameters are calculated by using only the upper template region. In embodiments, by expanding an area of a template region, more extensive space information can be obtained, thereby improving accuracy of a model whose model parameters are calculated by using only an upper template region.

In some embodiments, a quantity of sample rows of the left template region used when the at least one template region is the left template region is greater than a quantity of sample rows of the left template region used when the at least one template region includes the upper template region and the left template region; and/or, a quantity of sample columns of the left template region used when the at least one template region is the left template region is greater than a quantity of sample columns of the left template region used when the at least one template region includes the upper template region and the left template region.

Exemplarily, the quantity of the sample rows of the left template region used when the at least one template region is the left template region is greater than the quantity of the sample rows of the left template region used when the at least one template region includes the upper template region and the left template region by N (N is a positive integer). Alternatively, the quantity of the sample rows of the left template region used when the at least one template region is the left template region is an integer multiple of the quantity of the sample rows of the left template region used when the at least one template region includes the upper template region and the left template region. For example, the quantity of the sample rows of the left template region used when the at least one template region is the left template region is two times or another multiple of the quantity of the sample rows of the left template region used when the at least one template region includes the upper template region and the left template region.

Exemplarily, the quantity of the sample columns of the left template region used when the at least one template region is the left template region is greater than the quantity of the sample columns of the left template region used when the at least one template region includes the upper template region and the left template region by M (M is a positive integer). Alternatively, the quantity of the sample columns of the left template region used when the at least one template region is the left template region is an integer multiple of the quantity of the sample columns of the left template region used when the at least one template region includes the upper template region and the left template region. For example, the quantity of the sample columns of the left template region used when the at least one template region is the left template region is two times or another multiple of the quantity of the sample columns of the left template region used when the at least one template region includes the upper template region and the left template region.

A quantity of samples in the upper template region and the left template region used to calculate the model parameters is generally greater than a quantity of samples in only the left template region used to calculate the model parameters. Correspondingly, accuracy of the model whose model parameters are calculated by using the upper template region and the left template region is also higher than accuracy of the model whose model parameters are calculated by using only the left template region. In embodiments, by expanding an area of a template region, more extensive space information can be obtained, thereby improving accuracy of a model whose model parameters are calculated by using only a left template region.

FIG. 9 is an example of at least one template region according to an embodiment of this application.

As shown in FIG. 9, (a) in FIG. 9 is an example in which the at least one template region includes both an upper template region and a left template region, (b) in FIG. 9 is an example in which the at least one template region includes only an upper template region, and (c) in FIG. 9 is an example in which the at least one template region includes only a left template region. As shown in FIG. 9, in a case that the at least one template region includes only an upper template region or a left template region, the template region may be directly expanded. For example, as shown in (b) in FIG. 9, when the at least one template region includes only an upper template region, a height of the template region may be kept unchanged and a width of the template region may be increased (that is, an extended upper template region is added). As shown in (c) in FIG. 9, when the at least one template region includes only a left template region, a width of the template region may be kept unchanged and a height of the template region may be increased (that is, an extended left template region is added).

Certainly, a quantity of reference rows in a template region may be increased, to increase a quantity of samples and obtain more space information. For example, the upper template region includes two rows, three rows, or four rows of reconstructed samples, and the left template region includes two columns, three columns, or four columns of reconstructed samples. In this application, a template region is expanded. Different expansion manners can include more samples and more space information in calculation of model parameters. In some embodiments, a decoder may even add boundary check for selection of the at least one template region. For example, for unavailable samples, the decoder may not use the template region or may use some available samples in the template region, to calculate model parameters.

In some embodiments, S310 may include:
acquiring a first flag in a case that the IBC mode used for the current block is an IBC AMVP mode; and
in a case that the first flag indicates that the current block is allowed to use the IBC-LIC mode, determining that the IBC-LIC mode is used for the current block.

Exemplarily, when a value of the first flag is 1 or true, it indicates that the current block is allowed to use the IBC-LIC mode; or when a value of the first flag is 0 or false, it indicates that the current block is not allowed to use the IBC-LIC mode. Alternatively, when a value of the first flag is 0 or true, it indicates that the current block is allowed to use the IBC-LIC mode; or when a value of the first flag is 1 or false, it indicates that the current block is not allowed to use the IBC-LIC mode.

Exemplarily, in a case that the IBC mode used for the current block is the IBC AMVP mode, the decoder acquires the first flag by parsing a bitstream, and in a case that the first flag indicates that the current block is allowed to use the IBC-LIC mode, the decoder determines that the IBC-LIC mode is used for the current block.

In some embodiments, S320 may include:
acquiring, by the decoder, a first index; and
determining, by the decoder, a template region indicated by the first index as the at least one template region.

Exemplarily, when the value of the first index is 0, it indicates that the at least one template region includes the upper template region and the left template region; or when the value of the first index is 1, it indicates that the at least one template region is the upper template region; or when the value of the first index is 2, it indicates that the at least one template region is the left template region.

Certainly, the value of the first index and a template region may be in another correspondence, which is not specifically limited in this application.

For example, in another alternative embodiment, when the value of the first index is 2, it indicates that the at least one template region includes the upper template region and the left template region; or when the value of the first index is 1, it indicates that the at least one template region is the upper template region; or when the value of the first index is 0, it indicates that the at least one template region is the left template region.

Exemplarily, in a case that the IBC mode used for the current block is the IBC AMVP mode, the decoder acquires the first flag by parsing a bitstream. In a case that the first flag indicates that the current block is allowed to use the IBC-LIC mode, the decoder acquires the first index by decoding the bitstream, and determines the template region indicated by the first index as the at least one template region.

Exemplarily, the first index may be parsed based on a context or by using an equal probability method.

It should be noted that, because different template regions may correspond to different prediction modes in the IBC-LIC mode, in another alternative embodiment, “determining, by the decoder, a template region indicated by the first index as the at least one template region” may also be understood as or is equivalent to “determining, by the decoder, a prediction mode indicated by the first index as a prediction mode that is used for the current block and that belongs to the IBC-LIC mode”.

In some embodiments, S310 may include:
acquiring a second index in a case that the IBC mode used for the current block is an IBC advanced motion vector prediction AMVP mode; and
in a case that a value of the second index is a first value, determining that the IBC-LIC mode is not used for the current block; or
in a case that a value of the second index is a second value other than the first value, determining that the IBC-LIC mode is used for the current block,
where when the value of the second index is the second value, the at least one template region includes a template region indicated by the second value.

Exemplarily, when the value of the second index is 0, it indicates that the IBC-LIC mode is not used for the current block; or when the value of the second index is 1, it indicates that the at least one template region includes the upper template region and the left template region; or when the value of the second index is 2, it indicates that the at least one template region is the upper template region; or when the value of the second index is 3, it indicates that the at least one template region is the left template region.

Certainly, the value of the second index and a template region may be in another correspondence, which is not specifically limited in this application.

For example, in another alternative embodiment, when the value of the second index is 0, it indicates that the at least one template region includes the upper template region and the left template region; or when the value of the second index is 1, it indicates that the at least one template region is the upper template region; or when the value of the second index is 2, it indicates that the at least one template region is the left template region; or when the value of the second index is 3, it indicates that the IBC-LIC mode is not used for the current block.

Exemplarily, in a case that the IBC mode used for the current block is the IBC AMVP mode, the decoder acquires the second index by parsing a bitstream. In a case that the value of the second index is the first value, the decoder determines that the IBC-LIC mode is not used for the current block; or in a case that the value of the second index is the second value other than the first value, the decoder determines that the IBC-LIC mode is used for the current block. Further, when the value of the second index is the second value, the decoder determines the template region indicated by the second value as the at least one template region.

Exemplarily, the second index may be parsed based on a context or by using an equal probability method.

It should be noted that, since different template regions may correspond to different prediction modes in the IBC-LIC mode, in another alternative embodiment, “when the value of the second index is the second value, the at least one template region includes the template region indicated by the second value” may also be understood as or is equivalent to “when the value of the second index is the second value, the prediction mode that is used for the current block and that belongs to the IBC-LIC mode is a prediction mode indicated by the second value”.

In some embodiments, S310 may include:
in a case that the IBC mode used for the current block is an IBC merge mode, constructing, by the decoder, a merge candidate list;
acquiring, by the decoder, a third index, where the third index is used to indicate, in the merge candidate list, a block vector BV from the current block to a first reference block of the current block; and
in a case that the IBC-LIC mode is used for the first reference block, determining, by the decoder, that the IBC-LIC mode is used for the current block.

Exemplarily, in a case that the IBC mode used for the current block is the IBC merge mode, the decoder constructs the merge candidate list. Then, the decoder acquires the third index by parsing a bitstream, where the third index is used to indicate, in the merge candidate list, the block vector BV from the current block to the first reference block of the current block. In a case that the IBC-LIC mode is used for the first reference block, the decoder determines that the IBC-LIC mode is used for the current block. In a case that the IBC-LIC mode is not used for the first reference block, the decoder determines that the IBC-LIC mode is not used for the current block.

In some embodiments, S320 may include:
determining, by the decoder, the at least one template region based on an index used when performing illuminance compensation on the first reference block.

Exemplarily, in a case that the IBC mode used for the current block is the IBC merge mode, the decoder constructs the merge candidate list. Then, the decoder acquires the third index by parsing a bitstream, where the third index is used to indicate, in the merge candidate list, the block vector BV from the current block to the first reference block of the current block. In a case that the IBC-LIC mode is used for the first reference block, the decoder determines that the IBC-LIC mode is used for the current block. Further, the decoder determines the at least one template region based on the index used when performing illuminance compensation on the first reference block.

Exemplarily, the index used when performing illuminance compensation on the first reference block is an inherited index associated with the first reference block.

In an implementation, the index may be used to indicate a template region used when performing illuminance compensation on the first reference block.

In another implementation, the index may be used to indicate a prediction mode that is used for the first reference block and that belongs to the IBC-LIC mode. Optionally, the prediction mode that is used for the first reference block and that belongs to the IBC-LIC mode may be any one of the following modes: IBC-LIC-TL, IBC-LIC-T, or IBC-LIC-L. In IBC-LIC-TL, both an upper template region and a left template region are used. In IBC-LIC-T, only an upper template region is used. In IBC-LIC-L, only a left template region is used.

Certainly, in another alternative embodiment, in a case that the IBC mode used for the current block is the IBC merge mode, the decoder may also determine, in another manner, that the IBC-LIC mode is used or not used for the current block, and determine the at least one template region by using another method when the IBC-LIC mode is used for the current block. This is not specifically limited in this application. For example, for an IBC-LIC technology in the merge mode, the IBC-LIC mode used for the current block may not be obtained by inheritance, that is, the original upper and left template regions are used by default for parameter calculation. For another example, for the IBC-LIC technology in the merge mode, whether to use IBC-LIC may not be determined by inheriting peripheral information. Instead, an encoder calculates a distortion cost, and transmits, to a decoding end, whether to use IBC-LIC in a form of a flag bit and an index. The decoding end parses the IBC-LIC usage flag bit in the merge mode, to determine whether the IBC-LIC technology is used for a current coding unit.

It should be noted that, since different template regions may correspond to different prediction modes in the IBC-LIC mode, in another alternative embodiment, “determining, by the decoder, the at least one template region based on an index used when performing illuminance compensation on the first reference block” may also be understood as or is equivalent to “determining, by the decoder based on the index used when performing illuminance compensation on the first reference block, the prediction mode that is used for the current block and that belongs to the IBC-LIC mode”.

In some embodiments, before S320, the method 300 may further include:
acquiring, by a decoder, a second flag; and
in a case that the second flag indicates that the IBC mode used for the current block is an IBC merge mode, determining, by the decoder, that the IBC mode used for the current block is the IBC merge mode; or
in a case that the second flag indicates that the IBC mode used for the current block is not an IBC merge mode, determining, by the decoder, that the IBC mode used for the current block is an IBC AMVP mode.

Exemplarily, in a case that the second flag indicates that the IBC mode used for the current block is the IBC merge mode, the decoder determines that the IBC mode used for the current block is the IBC merge mode. Further, the decoder constructs the merge candidate list. Then, the decoder acquires the third index by parsing the bitstream, where the third index is used to indicate, in the merge candidate list, the block vector BV from the current block to the first reference block of the current block. In a case that the IBC-LIC mode is used for the first reference block, the decoder determines that the IBC-LIC mode is used for the current block. Further, the decoder may determine the index used when performing illuminance compensation on the first reference block as the at least one template region.

Exemplarily, in a case that the second flag indicates that the IBC mode used for the current block is not the IBC merge mode, the decoder determines that the IBC mode used for the current block is the IBC AMVP mode. Further, the decoder acquires the first flag by parsing the bitstream. In a case that the first flag indicates that the current block is allowed to use the IBC-LIC mode, the decoder acquires the first index by decoding the bitstream, and determines the template region indicated by the first index as the at least one template region.

Certainly, when determining that the IBC mode used for the current block is the IBC AMVP mode, the decoder may also acquire the second index by parsing the bitstream. In a case that the value of the second index is the first value, the decoder determines that the IBC-LIC mode is not used for the current block; or in a case that the value of the second index is the second value other than the first value, the decoder determines that the IBC-LIC mode is used for the current block. Further, when the value of the second index is the second value, the decoder determines the template region indicated by the second value as the at least one template region.

In some embodiments, S310 may include:
determining whether the IBC-LIC mode is used for the current block in a case that at least one of the following conditions is met:
a prediction type used for the current block is the IBC mode;
a current sequence to which the current block belongs is allowed to use the IBC-LIC mode;
an area of the current block is greater than or equal to a preset first threshold;
an area of the current block is less than or equal to a preset second threshold;
a type of a current image to which the current block belongs is a preset type; or the IBC mode used for the current block is not a mode that is not allowed to be used together with the IBC-LIC mode.

Exemplarily, the preset type may be an I-frame type.

In other words, whether to use the decoding method provided in this application may be limited based on an image type. For example, the decoding method provided in this application is allowed to be used only when a type of a current image is an I-frame, and is not allowed to be used when the type of the current image is a B-frame or a P-frame.

Exemplarily, in a case that the prediction type used for the current block is the IBC mode, the current sequence to which the current block belongs is allowed to use the IBC-LIC mode, the IBC mode used for the current block is not the IBC merge mode, and the area of the current block is greater than 32, the decoder acquires the first flag by parsing the bitstream. In a case that the first flag indicates that the current block is allowed to use the IBC-LIC mode, the decoder acquires the first index by decoding the bitstream, and determines the template region indicated by the first index as the at least one template region.

For example, assuming that the first flag is denoted as cu_ibc_lic_flag, a condition for parsing cu_ibc_lic_flag may be implemented by using the following syntax elements:

TABLE 2

| | |
|---|---|
| if (sps_ibc_lic_enable_flag && modeType == MODE_IBC | |
| && !merge_flag && cbWidth * cbHeight >32) { | |
| cu_{—}ibc_{—}lic_{—}flag | ae(v) |
| if (cu_ibc_lic_flag) | |
| cu_{—}ibc_{—}lic_{—}index | ae(v) |
| } | |
| else { | |
| cu_ibc_lic_flag = 0 | |
| } | |

As shown in Table 2, a syntax element in bold indicates that the syntax element needs to be parsed.

Herein, sps_ibc_lic_enable_flag is a sequence-level illuminance compensation enabling flag bit, cu_ibc_lic_flag is a IBC-LIC mode usage flag for a current coding unit, and cu_ibc_lic_index is an index of the IBC-LIC mode used for the current coding unit. Corresponding values of the following syntax elements have been obtained by parsing a bitstream before cu_ibc_lic_flag and cu_ibc_lic_index are parsed. modeType is a prediction type used for the current coding unit, and may have the following values: MODE_INTRA, which indicates intra prediction; MODE_INTER, which indicates inter prediction; and MODE_IBC, which indicates intra block copy prediction. merge_flag is a merge usage flag bit of the current coding unit. cbWidth and cbHeight are respectively a width of the current coding block and a height of the current coding block.

In addition, the condition for parsing cu_ibc_lic_flag may be determined based on coupling between existing encoding tools in a standard. That is, in a case that the current coding unit is allowed to use another intra block copy prediction technology but this technology cannot be used together with IBC-LIC, whether to parse an IBC-LIC usage flag bit of the current coding unit may be determined by first parsing a coding unit level usage flag bit for the foregoing technology. In a case that the coding unit level usage flag bit for the foregoing tool is true, the IBC-LIC usage flag bit of the current coding unit does not need to be parsed. Otherwise, the IBC-LIC usage flag bit of the current coding unit is parsed.

Exemplarily, in a case that the prediction type used for the current block is the IBC mode, the current sequence to which the current block belongs is allowed to use the IBC-LIC mode, the IBC mode used for the current block is not the IBC merge mode, the area of the current block is greater than 32, and the IBC mode used for the current block is not the mode that is not allowed to be used together with the IBC-LIC mode, the decoder acquires the first flag by parsing the bitstream. In a case that the first flag indicates that the current block is allowed to use the IBC-LIC mode, the decoder acquires the first index by decoding the bitstream, and determines the template region indicated by the first index as the at least one template region.

Reconstruction-reordered IBC (Reconstruction-reordered IBC, RRIBC) is used as an example. The syntax elements in Table 2 may be updated to the syntax elements in Table 3. RRIBC is a technology for reordering reconstructed samples and searching for a matching block, and a reordering operation includes but is not limited to horizontal flipping and vertical flipping.

TABLE 3

| | |
|---|---|
| if (sps_ibc_lic_enable_flag && modeType == MODE_IBC | |
| && !merge_flag && cbWidth * cbHeight >32 && | |
| cu_rribc_flip_type == 0) { | |
| cu_{—}ibc_{—}lic_{—}flag | ae(v) |
| if (cu_ibc_lic_flag) | |
| cu_{—}ibc_{—}lic_{—}index | ae(v) |
| } | |
| else { | |
| cu_ibc_lic_flag = 0 | |
| } | |

As shown in Table 3, cu_rribc_flip_type is an operation type of the RRIBC technology. In a case that cu_rribc_flip_type is 0, it indicates that the RRIBC technology is not used for the current coding unit. Otherwise, it indicates that the RRIBC technology is used for the current coding unit, and a value of cu_rribc_flip_type is an index of the operation type. Certainly, Table 3 shows only syntax parsing correlation between only the RRIBC tool and IBC-LIC. Similarly, there may be another intra block copy coding tool also in such a relationship. Details are not described herein again.

Exemplarily, in a case that the prediction type used for the current block is the IBC mode, the current sequence to which the current block belongs is allowed to use the IBC-LIC mode, the IBC mode used for the current block is not the IBC merge mode, and the area of the current block is greater than 32, the decoder acquires the second index by parsing the bitstream. In a case that the value of the second index is the first value, the decoder determines that the IBC-LIC mode is not used for the current block; or in a case that the value of the second index is the second value other than the first value, the decoder determines that the IBC-LIC mode is used for the current block. Further, when the value of the second index is the second value, the decoder determines the template region indicated by the second value as the at least one template region.

For example, assuming that the second index is denoted as cu_ibc_lic_mode, a condition for parsing cu_ibc_lic_mode may be implemented by using the following syntax elements:

TABLE 4

| | |
|---|---|
| if (sps_ibc_lic_enable_flag && modeType == MODE_IBC | |
| && !merge_flag && cbWidth * cbHeight >32) { | |
| cu_{—}ibc_{—}lic_{—}mode | ae(v) |
| } | |
| else { | |
| cu_ibc_lic_mode = 0 | |
| } | |

As shown in Table 4, cu_ibc_lic_mode represents an index of an IBC-LIC mode used for a current coding unit. In a case that cu_ibc_lic_mode is 0, it indicates that the IBC-LIC technology is not used for the current coding unit; or in a case that cu_ibc_lic_mode is 1, it indicates that samples in upper and left template regions are used to calculate parameters of a linear model; or in a case that cu_ibc_lic_mode is 2, it indicates that samples in an upper template region are used to calculate parameters of a linear model; or in a case that cu_ibc_lic_mode is 3, it indicates that samples in a left template region are used to calculate parameters of a linear model. Certainly, the value of cu_ibc_lic_mode and a template region may be in another correspondence, which is not limited in this application. For example, in a case that cu_ibc_lic_mode is 2, it indicates that samples in a left template region are used for calculation, or in a case that cu_ibc_lic_mode is 3, it indicates that samples in an upper template region are used for calculation. Details are not described herein again.

In some embodiments, the method 300 may further include:
acquiring a residual block of the current block; and
determining a reconstructed block of the current block based on the residual block and the second predicted block.

The following exemplarily describes syntax element parsing tables involved in this application.

The following describes the solutions of this application with reference to an embodiment.

### Embodiment 1

In embodiments, two new illuminance compensation modes are added based on the IBC-LIC technology, that is, parameters of a linear model are calculated by using only samples in an upper template region, and parameters of a linear model are calculated by using only samples in a left template region. For ease of description, in this specification, the original IBC-LIC mode, that is, both an upper template region and a left template region are used for modeling, is denoted as IBC-LIC-TL; the mode in which only the upper template region is used for modeling is denoted as IBC-LIC-T; and the model in which only the left template region is used for modeling is denoted as IBC-LIC-L.

At an encoding end, IBC matching search is performed on a current coding unit. The IBC-LIC-TL mode, the IBC-LIC-T mode, the IBC-LIC-L mode, and another IBC prediction mode are separately used to calculate cost information between reference blocks obtained by transform of different linear models and the original image block corresponding to the current coding unit. Cost information in different IBC prediction modes is compared, and a mode with the smallest cost is used as an optimal mode for the current coding block in an IBC AMVP mode. Prediction modes in a merge mode are used for the current coding unit. First, a merge mode list is constructed, and BV information is acquired from surrounding reference blocks. Information in the mode list further includes acquired information about IBC-LIC, IBC-CIIP, IBC-GPM, IBC-RR and other prediction modes corresponding to a block. In a case that the acquired information indicates that IBC-LIC is enabled, after acquiring a predicted block of the current coding unit according to the BV, linear transform is performed on predicted block by using the IBC-LIC technology, and an IBC-LIC mode index is acquired through inheritance.

At a decoding end, in a case that an IBC merge mode is used for a current coding unit, a bitstream is parsed, to obtain an index of a merge mode list, and a corresponding BV and related information are acquired according to the index. In a case that IBC-LIC is enabled, the IBC-LIC technology is used for the current coding unit; or in a case that IBC-LIC is disabled, the IBC-LIC technology is not used for the current coding unit. In a case that the IBC AMVP mode is used for the current coding unit, the bitstream is parsed, to obtain information related to IBC-LIC, such as a usage flag bit and a mode index. Whether to use IBC-LIC and selection of a template region related to IBC-LIC are determined based on the usage flag bit and the mode index. For the IBC merge mode, on one hand, a decoder needs to construct a merge candidate list, where the list is constructed by acquiring BVs of adjacent blocks and corresponding flag bit information. On the other hand, the decoder acquires a corresponding reference block according to a candidate BV in the list. In a case that an IBC-LIC usage flag bit in the flag bit information is true, the decoder needs to calculate parameters of a linear model and perform linear transform on the reference block. That is, in the current merge mode, IBC-LIC is obtained by inheritance, and whether IBC-LIC is used is not indicated by a flag bit.

An encoder traverses prediction modes. In a case that a type of a current prediction mode is an intra block copy mode, an IBC-LIC enable flag bit is acquired. The flag bit is a sequence-level flag bit, which indicates that the current encoder is allowed to use the IBC-LIC technology. For example, the flag bit may be in a form of sps_ibc_lic_enable_flag.

In this case, the encoder may execute the following steps:

### Step 1:

In a case that the IBC-LIC enable flag bit is true, and an area of the current coding unit is greater than a threshold 1 and less than a threshold 2, the encoding end tries an IBC-LIC prediction method, that is, step 2 is executed. Alternatively, in a case that the IBC-LIC enable flag bit or another condition such as an area condition is not met, the encoding end may not try the IBC-LIC prediction method, that is, step 2 is skipped and step 3 is directly executed.

### Step 2:

The encoder acquires information about reconstructed samples in upper and left template regions of the current coding unit and information about reconstructed samples in upper and left template regions of the reference block.

### Step 2.1:

The encoding end traverses various prediction modes in the IBC AMVP mode, and calculates corresponding rate distortion cost values.
Round 1: The encoding end tries the IBC-LIC-TL mode. A quantity of acquired reconstructed samples is determined in the same manner as in the foregoing descriptions, which depends on a width and a height of the current coding unit. The acquired reconstructed samples are modeled by using the method for calculating parameters of a linear model described above, to calculate a scaling factor a and a bias parameter b. Linear transform is performed on a predicted block by using transform parameters of scaling by a times and compensation by b, to obtain a final predicted block of the current coding unit. Subtraction is performed on the predicted block and an original sample corresponding to the current coding unit, to obtain a residual of the current coding unit. Operations such as transform and quantization are performed, to calculate a rate distortion cost value, which is denoted as cost1.
Round 2: The encoding end acquires only upper reconstruction reference samples adjacent to the current coding unit, and acquires only upper interpolated reconstructed samples adjacent to a corresponding coding unit in a reference frame. Then, a method that is the same as the method in round 1 is used, to calculate a rate distortion cost value, which is denoted as cost2.
Round 3: The encoding end acquires only left reconstruction reference samples adjacent to the current coding unit, and acquires only left interpolated reconstructed samples adjacent to a corresponding coding unit in a reference frame. Then, a method that is the same as the method in round 1 is used, to calculate a rate distortion cost value, which is denoted as cost3.

cost1, cost2, and cost3 are compared against each other. Then, the smallest cost value is denoted as costAmvpIbcLic, and information in the current illuminance compensation mode including an illuminance compensation mode index is saved. A mode index corresponding to cost1 is 0, a mode index corresponding to cost2 is 1, and a mode index corresponding to cost3 is 2.

### Step 2.2:

The encoding end constructs list information in the IBC merge mode, traverses candidate modes, and calculates corresponding rate distortion cost values.

The current coding unit traverses candidate BVs in the merge list. In a case that inherited information indicates that IBC-LIC in is enabled, a reference block of a current coding unit is acquired according to the BV information, samples in adjacent template regions of the current coding unit and the reference block are acquired according to the inherited IBC-LIC mode, to calculate parameters of a linear model. The reference block is transformed according to the parameters of the linear model by using steps as in the foregoing description, to obtain a final predicted block. Subtraction is performed on the predicted block and an original sample corresponding to the current coding unit, to obtain a residual of the current coding unit, and operations such as transform and quantization are performed, to calculate a rate distortion cost value, which is denoted as costIdx1. Other candidate BVs in the merge list are traversed, and rate distortion cost values costIdx2, costIdx3, costIdx4, and the like are calculated by using the same method.

Cost values costIdx1, costIdx2 and the others are compared against each other, and a smaller value is denoted as costMergeIbc.

### Step 3:

The encoding end traverses other inter prediction technologies, calculates rate distortion cost values corresponding to the technologies, and selects a prediction mode corresponding to the smallest cost value as an optimal prediction mode for the current coding unit.

In a case that costAmvpIbcLic is the smallest value, an intra block copy illuminance compensation technology is used for the current coding unit. A coding unit level usage flag bit for the illuminance compensation technology needs to be set to true and written into a bitstream. In addition, an index of an intra block copy illuminance compensation mode also needs to be written into the bitstream. In a case that costMergeIbc is the smallest value, the IBC technology in the merge mode is used for the current coding unit. A merge flag bit of IBC is set to true and written into a bitstream, and a merge index is also written into the bitstream. In a case that the current coding unit is allowed to use an illuminance compensation technology and costLic is not the smallest value, the illuminance compensation technology is not used for the current coding unit, and a coding unit level usage flag bit for the illuminance compensation technology needs to be set to false and written into a bitstream. Otherwise, information about another optimal prediction mode or the like is written into a bitstream, which is not strongly correlated with this technology. Therefore, details are not described herein.

### Step 4:

After traversing all coding units, the encoder performs processing such as in-loop filtering and entropy encoding, to output a bitstream.

The decoding end parses or acquires an LIC enable flag bit, where the flag bit is a sequence-level flag bit (sps_ibc_lic_enable_flag), which indicates that the current decoder is allowed to use the IBC-LIC technology.

In this case, the decoder may execute the following steps:

### Step 1:

The decoder parses a bitstream, to acquire a prediction type of a current coding unit. In a case that the prediction type is an IBC mode, the decoder parses a merge usage flag bit of the current coding unit. In a case that the merge usage flag bit of the current coding unit is not true, sps_ibc_lic_enable_flag is true, and an area of the current coding unit is greater than a threshold 1 and less than a threshold 2, the decoder parses the bitstream, to acquire an IBC-LIC usage flag bit (cu_ibc_lic_flag). In a case that the usage flag bit is true, the decoder parses an IBC-LIC mode index (cu_ibc_lic_index). Herein, in a case that cu_ibc_lic_index is 0, it indicates that upper and left template regions are used to calculate parameters of a linear model; or in a case that cu_ibc_lic_index is 1, it indicates that an upper template region is used to calculate parameters of a linear model; or in a case that cu_ibc_lic_index is 2, it indicates that a left template region is used to calculate parameters of a linear model.

In a case that the usage flag bit cu_ibc_lic_flag of the current coding unit is false, step 3 is executed.

In a case that the current merge usage flag bit is true, a merge index is obtained by parsing, and corresponding IBC-LIC information is acquired according to the merge index. In a case that the inherited IBC-LIC usage flag bit is true, step 2 is executed according to the inherited IBC-LIC mode index. Otherwise, step 3 is executed.

It should be noted that, in embodiments, cu_ibc_lic_flag is a flag bit at a coding unit level, and needs to be parsed only in an AMVP mode. For the merge mode, the decoding end parses the merge index, constructs a candidate list that is the same as the candidate list at the encoding end, and acquires corresponding candidate BVs and usage information of each flag bit according to the merge index.

### Step 2:

The decoder acquires, according to the index obtained by parsing in the previous step, reconstructed samples that are in a template region adjacent to the current coding unit and acquired by the encoding end. A quantity of the acquired reconstructed samples is determined in the same manner as in the foregoing descriptions, which depends on a width or a height of the current coding unit. In addition, the decoder also acquires reconstructed samples in a template region adjacent to a corresponding coding unit in a reference frame. The acquired reconstructed samples are modeled by using the method for calculating parameters of a linear model described above, to calculate a scaling factor a and a bias parameter b. Linear transform is performed on a predicted block by using transform parameters of scaling by a times and compensation by b, to obtain a final predicted block of the current coding unit.

### Step 3:

The decoder parses information such as a usage flag bit or an index of another technology, and obtains a final predicted block of the current coding unit according to information obtained by parsing.

### Step 4:

The decoder parses a bitstream, to acquire residual information, and performs inverse quantization and inverse transform, to obtain time domain residual information. Then, the decoder adds the final predicted block and the time domain residual information, to obtain a reconstructed sample block.

### Step 5:

The decoder processes all reconstructed sample blocks by using technologies such as in-loop filtering, to obtain a final reconstructed image, which may be used as a video output or reference for subsequent decoding.

It should be noted that, in embodiments, whether to use IBC-LIC at a coding unit level is limited. In a case that a product of the width and the height of the current coding unit is less than 32 or greater than 256, an illuminance compensation technology is not allowed to be used. That is, the threshold 1 is 32 and the threshold 2 is 256. However, this limitation may be modified according to coupling between technologies. For example, in some embodiments, IBC-LIC is limited to be not used for a coding unit whose width-height product is less than 32, but is not limited for a coding unit with a large area.

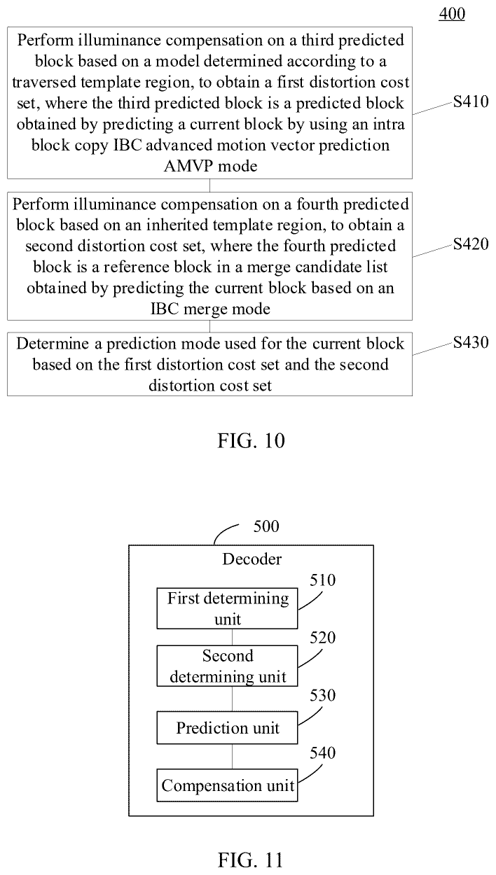

The following describes an encoding method according to an embodiment of this application from a perspective of an encoder with reference to FIG. 10.

FIG. 10 is a schematic flowchart of an encoding method 400 according to an embodiment of this application. It should be understood that the encoding method 400 may be executed by an encoder. For example, the method may be applied to the encoding framework 100 shown in FIG. 1 or another similar encoding framework. For ease of description, the following uses an encoder as an example for description.

As shown in FIG. 10, the encoding method 400 may include some or all of the following:
S410: Perform illuminance compensation on a third predicted block based on a model determined according to a traversed template region, to obtain a first distortion cost set, where the third predicted block is a predicted block obtained by predicting a current block by using an intra block copy IBC advanced motion vector prediction AMVP mode.
S420: Perform illuminance compensation on a fourth predicted block based on an inherited template region, to obtain a second distortion cost set, where the fourth predicted block is a reference block in a merge candidate list obtained by predicting the current block based on an IBC merge mode.
S430: Determine a prediction mode used for the current block based on the first distortion cost set and the second distortion cost set.

In some embodiments, the traversed template region includes at least one of the following:
an upper template region; or
a left template region.

In some embodiments, a sampling step used when the traversed template region is the upper template region or the left template region is less than a sampling step used when the traversed template region includes the upper template region and the left template region.

The model determined according to the traversed template region is a model determined based on a sample obtained from the traversed template region according to the sampling step.

In some embodiments, a quantity of sample rows of the upper template region used when the traversed template region is the upper template region is greater than a quantity of sample rows of the upper template region used when the traversed template region includes the upper template region and the left template region; and/or, a quantity of sample columns of the upper template region used when the traversed template region is the upper template region is greater than a quantity of sample columns of the upper template region used when the traversed template region includes the upper template region and the left template region.

In some embodiments, a quantity of sample rows of the left template region used when the traversed template region is the left template region is greater than a quantity of sample rows of the left template region used when the traversed template region includes the upper template region and the left template region; and/or, a quantity of sample columns of the left template region used when the traversed template region is the left template region is greater than a quantity of sample columns of the left template region used when the traversed template region includes the upper template region and the left template region.

In some embodiments, S410 may include:
acquiring an upper template region of the current block, a left template region of the current block, an upper template region of the third predicted block, and a left template region of the third predicted block.

The first distortion cost set includes:
a distortion cost obtained by performing illuminance compensation on the third predicted block based on a model obtained according to the upper template region of the current block and the upper template region of the third predicted block;
a distortion cost obtained by performing illuminance compensation on the third predicted block based on a model obtained according to the left template region of the current block and the left template region of the third predicted block; and
a distortion cost obtained by performing illuminance compensation on the third predicted block based on a model obtained according to the upper template region of the current block, the left template region of the current block, the upper template region of the third predicted block, and the left template region of the third predicted block.

In some embodiments, S420 may include:
constructing the merge candidate list.

For a first candidate reference block in the merge candidate list, in a case that an IBC-LIC mode is used for the first candidate reference block, the second distortion cost set includes:
a distortion cost obtained by performing illuminance compensation on the first candidate reference block based on a model determined according to a template region used by the first candidate reference block.

In some embodiments, S430 may include:
determining that the prediction mode used for the current block is the IBC AMVP mode in a case that the smallest value in the first distortion cost set is less than the smallest value in the second distortion cost set and a distortion cost of the current block in any other prediction mode.

In some embodiments, the method 400 may further include:
determining a first flag, where the first flag indicates whether the current block is allowed to use an intra block copy local illuminance compensation IBC-LIC mode; and
encoding the first flag.

In some embodiments, the method 400 may further include:
determining a first index, where the first index indicates at least one template region for illuminance compensation; and
encoding the first index.

In some embodiments, the method 400 may further include:
determining a second index,
where in a case that a value of the second index is a first value, the second index indicates that an intra block copy local illuminance compensation IBC-LIC mode is not used for the current block; or in a case that a value of the second index is a second value other than the first value, the second index indicates at least one template region for illuminance compensation; and
encoding the second index.

In some embodiments, S430 may include:
determining that the prediction mode used for the current block is the IBC merge mode in a case that the smallest value in the second distortion cost set is less than the smallest value in the first distortion cost set and a distortion cost of the current block in any other prediction mode.

In some embodiments, the method 400 may further include:
determining a third index, where the third index is used to indicate, in the merge candidate list, a block vector BV from the current block to a first reference block of the current block; and
encoding the third index.

In some embodiments, the method 400 may further include:
determining a second flag, where the second flag indicates whether an IBC mode used for the current block is the IBC merge mode; and
encoding the second flag.

In some embodiments, S410 may include:
performing illuminance compensation on the third predicted block based on the model determined according to the traversed template region, to obtain the first distortion cost set in a case that at least one of the following conditions is met:
a prediction type used for the current block is the IBC mode;
a current sequence to which the current block belongs is allowed to use an IBC-LIC mode;
an area of the current block is greater than or equal to a preset first threshold;
an area of the current block is less than or equal to a preset second threshold;
a type of a current image to which the current block belongs is a preset type; or
an IBC mode used for the current block is not a mode that is not allowed to be used together with an IBC-LIC mode.

The foregoing describes in detail the preferred implementations of this application with reference to the accompanying drawings. However, this application is not limited to specific details in the foregoing implementations. Within the scope of the technical concepts of this application, various simple variations may be implemented to the technical solutions in this application, and these simple variations are all within the protection scope of this application. For example, specific technical features described in the foregoing specific implementations may be combined in any suitable manner in the case of no conflict. To avoid unnecessary repetition, various possible combination manners are not described in this application. For another example, any combination may alternatively be performed between different implementations of this application, provided that the combination is not contrary to the idea of this application, and the combination shall also be considered as the content disclosed in this application. It should be further understood that, in the method embodiments of this application, sequence numbers of the foregoing processes do not mean execution sequences. The execution sequences of the processes shall be determined based on functions and internal logic of the processes, and shall not be construed as any limitation on the implementation processes of embodiments of this application.

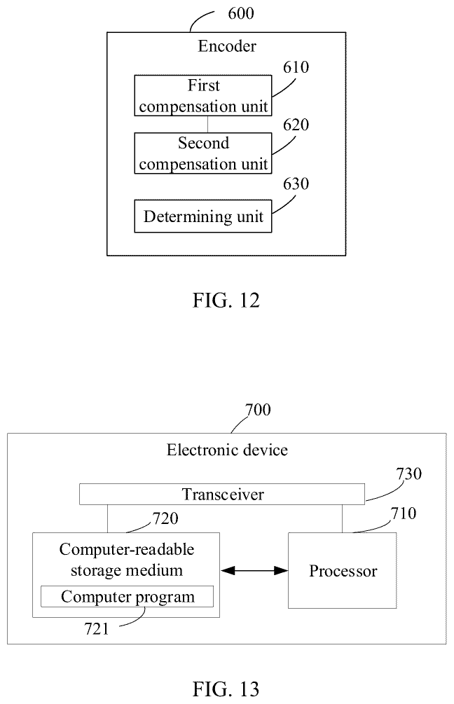

The foregoing describes in detail the method embodiments of this application. With reference to FIG. 11 and FIG. 12, the following describes in detail the apparatus embodiments of this application.

FIG. 11 is a schematic block diagram of a decoder 500 according to an embodiment of this application.

As shown in FIG. 11, the decoder 500 may include:
a first determining unit 510, configured to determine whether an intra block copy local illuminance compensation IBC-LIC mode is used for a current block;
a second determining unit 520, configured to: in a case that it is determined that the IBC-LIC mode is used for the current block, determine at least one template region for illuminance compensation, where the at least one template region is used to determine a first model;
a prediction unit 530, configured to predict the current block based on an IBC mode used for the current block, to obtain a first predicted block of the current block; and
a compensation unit 540, configured to perform illuminance compensation on the first predicted block based on the first model, to obtain a second predicted block of the current block.

In some embodiments, the at least one template region includes at least one of the following:
an upper template region; or
a left template region.

In some embodiments, a sampling step used when the at least one template region is the upper template region or the left template region is less than a sampling step used when the at least one template region includes the upper template region and the left template region.

A sample obtained from the at least one template region according to the sampling step is used to determine the first model.

In some embodiments, a quantity of sample rows of the upper template region used when the at least one template region is the upper template region is greater than a quantity of sample rows of the upper template region used when the at least one template region includes the upper template region and the left template region; and/or, a quantity of sample columns of the upper template region used when the at least one template region is the upper template region is greater than a quantity of sample columns of the upper template region used when the at least one template region includes the upper template region and the left template region.

In some embodiments, a quantity of sample rows of the left template region used when the at least one template region is the left template region is greater than a quantity of sample rows of the left template region used when the at least one template region includes the upper template region and the left template region; and/or, a quantity of sample columns of the left template region used when the at least one template region is the left template region is greater than a quantity of sample columns of the left template region used when the at least one template region includes the upper template region and the left template region.

In some embodiments, the first determining unit 510 is specifically configured to:
acquire a first flag in a case that the IBC mode used for the current block is an IBC advanced motion vector prediction AMVP mode; and
in a case that the first flag indicates that the current block is allowed to use the IBC-LIC mode, determine that the IBC-LIC mode is used for the current block.

In some embodiments, the second determining unit 520 is specifically configured to:
acquire a first index; and
determine a template region indicated by the first index as the at least one template region.

In some embodiments, the first determining unit 510 is specifically configured to:
acquire a second index in a case that the IBC mode used for the current block is an IBC advanced motion vector prediction AMVP mode; and
in a case that a value of the second index is a first value, determine that the IBC-LIC mode is not used for the current block; or
in a case that a value of the second index is a second value other than the first value, determine that the IBC-LIC mode is used for the current block.

When the value of the second index is the second value, the at least one template region includes a template region indicated by the second value.

In some embodiments, the first determining unit 510 is specifically configured to:
construct a merge candidate list in a case that the IBC mode used for the current block is an IBC merge mode;
acquire a third index, where the third index is used to indicate, in the merge candidate list, a block vector BV from the current block to a first reference block of the current block; and
in a case that the IBC-LIC mode is used for the first reference block, determine that the IBC-LIC mode is used for the current block.

In some embodiments, the second determining unit 520 is specifically configured to:
determine the at least one template region based on an index used when performing illuminance compensation on the first reference block.

In some embodiments, before determining the at least one template region for illuminance compensation, the second determining unit 520 is further configured to:
acquire a second flag; and
in a case that the second flag indicates that the IBC mode used for the current block is an IBC merge mode, determine that the IBC mode used for the current block is the IBC merge mode; or
in a case that the second flag indicates that the IBC mode used for the current block is not an IBC merge mode, determine that the IBC mode used for the current block is an IBC advanced motion vector prediction AMVP mode.

In some embodiments, the first determining unit 510 is specifically configured to:
determine whether the intra block copy local illuminance compensation IBC-LIC mode is used for the current block in a case that at least one of the following conditions is met:
a prediction type used for the current block is the IBC mode;
a current sequence to which the current block belongs is allowed to use the IBC-LIC mode;
an area of the current block is greater than or equal to a preset first threshold;
an area of the current block is less than or equal to a preset second threshold;
a type of a current image to which the current block belongs is a preset type; or
the IBC mode used for the current block is not a mode that is not allowed to be used together with the IBC-LIC mode.

In some embodiments, the prediction unit 530 is further configured to:
acquire a residual block of the current block; and
determine a reconstructed block of the current block based on the residual block and the second predicted block.

FIG. 12 is a schematic block diagram of an encoder 600 according to an embodiment of this application.

As shown in FIG. 12, the encoder 600 may include:
a first compensation unit 610, configured to perform illuminance compensation on a third predicted block based on a model determined according to a traversed template region, to obtain a first distortion cost set, where the third predicted block is a predicted block obtained by predicting a current block by using an intra block copy IBC advanced motion vector prediction AMVP mode;
a second compensation unit 620, configured to perform illuminance compensation on a fourth predicted block based on an inherited template region, to obtain a second distortion cost set, where the fourth predicted block is a reference block in a merge candidate list obtained by predicting the current block based on an IBC merge mode; and
a determining unit 630, configured to determine a prediction mode used for the current block based on the first distortion cost set and the second distortion cost set. In some embodiments, the traversed template region includes at least one of the following:
an upper template region; or
a left template region.

In some embodiments, a sampling step used when the traversed template region is the upper template region or the left template region is less than a sampling step used when the traversed template region includes the upper template region and the left template region.

The model determined according to the traversed template region is a model determined based on a sample obtained from the traversed template region according to the sampling step.

In some embodiments, a quantity of sample rows of the upper template region used when the traversed template region is the upper template region is greater than a quantity of sample rows of the upper template region used when the traversed template region includes the upper template region and the left template region; and/or, a quantity of sample columns of the upper template region used when the traversed template region is the upper template region is greater than a quantity of sample columns of the upper template region used when the traversed template region includes the upper template region and the left template region.

In some embodiments, a quantity of sample rows of the left template region used when the traversed template region is the left template region is greater than a quantity of sample rows of the left template region used when the traversed template region includes the upper template region and the left template region; and/or, a quantity of sample columns of the left template region used when the traversed template region is the left template region is greater than a quantity of sample columns of the left template region used when the traversed template region includes the upper template region and the left template region.

In some embodiments, the first compensation unit 610 is specifically configured to:
acquire an upper template region of the current block, a left template region of the current block, an upper template region of the third predicted block, and a left template region of the third predicted block.

The first distortion cost set includes:
a distortion cost obtained by performing illuminance compensation on the third predicted block based on a model obtained according to the upper template region of the current block and the upper template region of the third predicted block;
a distortion cost obtained by performing illuminance compensation on the third predicted block based on a model obtained according to the left template region of the current block and the left template region of the third predicted block; and
a distortion cost obtained by performing illuminance compensation on the third predicted block based on a model obtained according to the upper template region of the current block, the left template region of the current block, the upper template region of the third predicted block, and the left template region of the third predicted block.

In some embodiments, the second compensation unit 620 is specifically configured to:
construct the merge candidate list.

For a first candidate reference block in the merge candidate list, in a case that an IBC-LIC mode is used for the first candidate reference block, the second distortion cost set includes:
a distortion cost obtained by performing illuminance compensation on the first candidate reference block based on a model determined according to a template region used by the first candidate reference block.

In some embodiments, the determining unit 630 is specifically configured to:
determine that the prediction mode used for the current block is the IBC AMVP mode in a case that the smallest value in the first distortion cost set is less than the smallest value in the second distortion cost set and a distortion cost of the current block in any other prediction mode.

In some embodiments, the determining unit 630 is further configured to:
determine a first flag, where the first flag indicates whether the current block is allowed to use an intra block copy local illuminance compensation IBC-LIC mode; and
encode the first flag.

In some embodiments, the determining unit 630 is further configured to:
determine a first index, where the first index indicates at least one template region for illuminance compensation; and
encode the first index.

In some embodiments, the determining unit 630 is further configured to:
determine a second index,
where in a case that a value of the second index is a first value, the second index indicates that an intra block copy local illuminance compensation IBC-LIC mode is not used for the current block; or in a case that a value of the second index is a second value other than the first value, the second index indicates at least one template region for illuminance compensation; and
encode the second index.

In some embodiments, the determining unit 630 is specifically configured to:
determine that the prediction mode used for the current block is the IBC merge mode in a case that the smallest value in the second distortion cost set is less than the smallest value in the first distortion cost set and a distortion cost of the current block in any other prediction mode.

In some embodiments, the determining unit 630 is further configured to:
determine a third index, where the third index is used to indicate, in the merge candidate list, a block vector BV from the current block to a first reference block of the current block; and
encode the third index.

In some embodiments, the determining unit 630 is further configured to:
determine a second flag, where the second flag indicates whether an IBC mode used for the current block is the IBC merge mode; and
encode the second flag.

In some embodiments, the first compensation unit 610 is specifically configured to:
perform illuminance compensation on the third predicted block based on the model determined according to the traversed template region, to obtain the first distortion cost set in a case that at least one of the following conditions is met:
a prediction type used for the current block is the IBC mode;
a current sequence to which the current block belongs is allowed to use an IBC-LIC mode;
an area of the current block is greater than or equal to a preset first threshold;
an area of the current block is less than or equal to a preset second threshold;
a type of a current image to which the current block belongs is a preset type; or
an IBC mode used for the current block is not a mode that is not allowed to be used together with an IBC-LIC mode.

It should be understood that the apparatus embodiments may correspond to the method embodiments. For similar descriptions, reference may be made to the method embodiments. To avoid repetition, details are not described herein again. Specifically, the decoder 500 shown in FIG. 11 may correspond to a corresponding body that executes the method 300 in embodiments of this application, and the foregoing and other operations and/or functions of the units in the decoder 500 are respectively used to implement a corresponding procedure in the methods such as the method 300. The encoder 600 shown in FIG. 12 may correspond to a corresponding body that executes the method 400 in embodiments of this application, that is, the foregoing and other operations and/or functions of the units in the encoder 600 are respectively used to implement a corresponding procedure in the methods such as the method 400. To avoid repetition, details are not described herein again.

It should be further understood that units in the decoder 500 or the encoder 600 in embodiments of this application may be separately or completely combined into a single unit or several other units, or one or more of the units may be further split into a plurality of units that are functionally smaller. This may implement a same operation without affecting implementation of the technical effect of embodiments of this application. The foregoing units are divided based on logical functions. In actual application, functions of one unit may be implemented by a plurality of units, or functions of a plurality of units are implemented by one unit. In other embodiments of this application, the decoder 500 or the encoder 600 may also include another unit. In actual application, these functions may also be implemented by another unit, and may be implemented by a plurality of units in cooperation. According to another embodiment of this application, a computer program (including program code) that can execute steps in a corresponding method may be run on a general-purpose computing device that includes a processing element such as a central processing unit (CPU), a random access storage medium (RAM), a read-only storage medium (ROM), and a storage element, to construct the decoder 500 or the encoder 600 in embodiments of this application, and implement an encoding method or a decoding method in embodiments of this application. A computer program may be recorded in, for example, a computer-readable storage medium, and is installed in an electronic device by using the computer-readable storage medium, to implement a corresponding method in embodiments of this application.

In other words, the foregoing units may be implemented in a hardware form, may be implemented in an instruction in a software form, or may be implemented in a combination of software and hardware. Specifically, the steps of the method embodiments in this application may be completed by using an integrated logic circuit of hardware in the processor and/or an instruction in a form of software. The steps of the method disclosed with reference to embodiments of this application may be directly executed by the hardware decoding processor, or may be executed by using a combination of hardware and software in the decoding processor. Optionally, the software may be located in a mature storage medium in the art such as a random access memory, a flash memory, a read-only memory, a programmable read-only memory, an electrically erasable programmable memory, and a register. The storage medium is located in a memory. The processor reads information in the memory and completes the steps in the foregoing method embodiments in combination with hardware of the processor.

FIG. 13 is a schematic structural diagram of an electronic device 700 according to an embodiment of this application.

As shown in FIG. 13, the electronic device 700 includes at least a processor 712 and a computer-readable storage medium 720. The processor 712 and the computer-readable storage medium 720 may be connected by using a bus or in another manner. The computer-readable storage medium 720 is configured to store a computer program 721. The computer program 721 includes computer instructions. The processor 712 is configured to execute the computer instructions stored in the computer-readable storage medium 720. The processor 712 is a computing core and a control core of the electronic device 700, is adapted to implement one or more computer instructions, and is specifically adapted to load and execute one or more computer instructions, to implement a corresponding method procedure or a corresponding function.

Exemplarily, the processor 712 may also be referred to as a central processing unit (Central Processing Unit, CPU). The processor 712 may include but is not limited to a general purpose processor, a digital signal processor (Digital Signal Processor, DSP), an application-specific integrated circuit (Application Specific Integrated Circuit, ASIC), a field programmable gate array (Field Programmable Gate Array, FPGA) or another programmable logic device, a transistor logic device, a discrete hardware component, and the like.

Exemplarily, the computer-readable storage medium 720 may be a high-speed RAM memory, or may be a non-volatile memory, for example, at least one disk memory. Optionally, the computer-readable storage medium 720 may be at least one computer-readable storage medium located far away from the processor 712. Specifically, the computer-readable storage medium 720 includes but is not limited to a volatile memory and/or a non-volatile memory. The non-volatile memory may be a read-only memory (Read-Only Memory, ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (Random Access Memory, RAM), and is used as an external cache. By way of example but not limitative description, many forms of RAMs are available, for example, a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDR SDRAM), an enhanced synchronous dynamic random access memory (Enhanced SDRAM, ESDRAM), a synchlink dynamic random access memory (synch link DRAM, SLDRAM), and a direct rambus random access memory (Direct Rambus RAM, DR RAM).

Exemplarily, the electronic device 700 may be an encoder or an encoding framework related to an embodiment of this application. The computer-readable storage medium 720 stores a first computer instruction. The processor 712 loads and executes the first computer instruction stored in the computer-readable storage medium 720, to implement a corresponding step in the encoding method provided in embodiments of this application. In other words, the first computer instruction in the computer-readable storage medium 720 is loaded by the processor 712 and a corresponding step is executed. To avoid repetition, details are not described herein again.

Exemplarily, the electronic device 700 may be a decoder or a decoding framework involved in an embodiment of this application. The computer-readable storage medium 720 stores a second computer instruction. The processor 712 loads and executes the second computer instruction stored in the computer-readable storage medium 720, to implement a corresponding step in the decoding method provided in embodiments of this application. In other words, the second computer instruction in the computer-readable storage medium 720 is loaded by the processor 712 and a corresponding step is executed. To avoid repetition, details are not described herein again.

According to another aspect of this application, this application further provides a codec system, including the foregoing encoder and decoder.

According to another aspect of this application, this application further provides a computer-readable storage medium (Memory), where the computer-readable storage medium is a memory device in an electronic device 700, and is configured to store a program and data. For example, the computer-readable storage medium may be the computer-readable storage medium 720. It may be understood that the computer-readable storage medium 720 herein may include a built-in storage medium in the electronic device 700, and certainly may also include an extended storage medium supported by the electronic device 700. A computer-readable storage medium provides storage space, and the storage space stores an operating system of the electronic device 700. In addition, one or more computer instructions suitable for being loaded and executed by the processor 712 are further stored in the storage space. These computer instructions may be one or more computer programs 721 (including program code).

According to another aspect of this application, this application further provides a computer program product or a computer program, where the computer program product or the computer program includes computer instructions, and the computer instructions are stored in a computer-readable storage medium. For example, the computer program may be the computer program 721. In this case, the data processing device 700 may be a computer. The processor 712 reads the computer instructions from the computer-readable storage medium 720, and the processor 712 executes the computer instructions, so that the computer executes the encoding method or the decoding method provided in the foregoing optional manners.

In other words, when software is used to implement embodiments, the foregoing embodiments may be implemented completely or partially in a form of a computer program product. The computer program product includes one or more computer instructions. When the computer program instructions are loaded and executed on a computer, the procedure of embodiments of this application are completely or partially run or the functions of embodiments of this application are completely or partially implemented. The computer may be a general-purpose computer, a dedicated computer, a computer network, or another programmable apparatus. The computer instruction may be stored in a computer-readable storage medium or transmitted from one computer-readable storage medium to another computer-readable storage medium. For example, the computer instruction may be transmitted from one website site, computer, server, or data center to another website site, computer, server, or data center in a wired (such as coaxial cable, optical fiber, digital subscriber line (DSL)), or wireless (such as infrared, wireless, and microwave) manner.

A person of ordinary skill in the art may be aware that, units and procedure steps in examples described in combination with embodiments disclosed in this specification can be implemented by electronic hardware or a combination of computer software and electronic hardware. Whether these functions are executed in hardware or software depends on the specific application and design constraints of the technical solution. A person skilled in the art may use different methods to implement the described functions for each particular application, but it should not be considered that the implementation goes beyond the scope of this application.

Finally, it should be noted that the foregoing content is merely a specific implementation of this application, but the protection scope of this application is not limited thereto. Any change or replacement readily figured out by a person skilled in the art within the technical scope disclosed in this application shall fall within the protection scope of this application. Therefore, the protection scope of this application shall be subject to the protection scope of the claims.

What is claimed is:

1. A decoding method, comprising:
determining whether an intra block copy local illuminance compensation (IBC-LIC) mode is used for a current block;
in a case that it is determined that the IBC-LIC mode is used for the current block, determining at least one template region for illuminance compensation, wherein the at least one template region is used to determine a first model;
predicting the current block based on an IBC mode used for the current block, to obtain a first predicted block of the current block; and
performing illuminance compensation on the first predicted block based on the first model, to obtain a second predicted block of the current block.

2. The method according to claim 1, wherein the at least one template region comprises at least one of following:
an upper template region; or
a left template region.

3. The method according to claim 2, wherein a sampling step used when the at least one template region is the upper template region or the left template region is less than a sampling step used when the at least one template region comprises the upper template region and the left template region,
wherein a sample obtained from the at least one template region according to the sampling step is used to determine the first model.

4. The method according to claim 2, wherein a quantity of sample rows of the upper template region used when the at least one template region is the upper template region is greater than a quantity of sample rows of the upper template region used when the at least one template region comprises the upper template region and the left template region; and/or, a quantity of sample columns of the upper template region used when the at least one template region is the upper template region is greater than a quantity of sample columns of the upper template region used when the at least one template region comprises the upper template region and the left template region.

5. The method according to claim 2, wherein a quantity of sample rows of the left template region used when the at least one template region is the left template region is greater than a quantity of sample rows of the left template region used when the at least one template region comprises the upper template region and the left template region; and/or, a quantity of sample columns of the left template region used when the at least one template region is the left template region is greater than a quantity of sample columns of the left template region used when the at least one template region comprises the upper template region and the left template region.

6. The method according to claim 1, wherein the determining whether the intra block copy local illuminance compensation (IBC-LIC) mode is used for the current block comprises:
acquiring a first flag in a case that the IBC mode used for the current block is an IBC advanced motion vector prediction (AMVP) mode; and
in a case that the first flag indicates that the current block is allowed to use the IBC-LIC mode, determining that the IBC-LIC mode is used for the current block.

7. The method according to claim 6, wherein the determining the at least one template region for illuminance compensation comprises:
acquiring a first index; and
determining a template region indicated by the first index as the at least one template region.

8. The method according to claim 1, wherein the determining whether the intra block copy local illuminance compensation (IBC-LIC) mode is used for the current block comprises:
acquiring a second index in a case that the IBC mode used for the current block is an IBC advanced motion vector prediction (AMVP) mode; and
in a case that a value of the second index is a first value, determining that the IBC-LIC mode is not used for the current block; or
in a case that a value of the second index is a second value other than the first value, determining that the IBC-LIC mode is used for the current block,
wherein when the value of the second index is the second value, the at least one template region comprises a template region indicated by the second value.

9. An encoding method, comprising:
performing illuminance compensation on a third predicted block based on a model determined according to a traversed template region, to obtain a first distortion cost set, wherein the third predicted block is a predicted block obtained by predicting a current block by using an intra block copy (IBC) advanced motion vector prediction (AMVP) mode;
performing illuminance compensation on a fourth predicted block based on an inherited template region, to obtain a second distortion cost set, wherein the fourth predicted block is a reference block in a merge candidate list obtained by predicting the current block based on an IBC merge mode; and
determining a prediction mode used for the current block based on the first distortion cost set and the second distortion cost set.

10. The method according to claim 9, wherein the traversed template region comprises at least one of following:
an upper template region; or
a left template region.

11. The method according to claim 10, wherein a sampling step used when the traversed template region is the upper template region or the left template region is less than a sampling step used when the traversed template region comprises the upper template region and the left template region,
wherein the model determined according to the traversed template region is a model determined based on a sample obtained from the traversed template region according to the sampling step.

12. The method according to claim 10, wherein a quantity of sample rows of the upper template region used when the traversed template region is the upper template region is greater than a quantity of sample rows of the upper template region used when the traversed template region comprises the upper template region and the left template region; and/or, a quantity of sample columns of the upper template region used when the traversed template region is the upper template region is greater than a quantity of sample columns of the upper template region used when the traversed template region comprises the upper template region and the left template region.

13. The method according to claim 10, wherein a quantity of sample rows of the left template region used when the traversed template region is the left template region is greater than a quantity of sample rows of the left template region used when the traversed template region comprises the upper template region and the left template region; and/or, a quantity of sample columns of the left template region used when the traversed template region is the left template region is greater than a quantity of sample columns of the left template region used when the traversed template region comprises the upper template region and the left template region.

14. The method according to claim 9, wherein the determining the prediction mode used for the current block based on the first distortion cost set and the second distortion cost set comprises:
determining that the prediction mode used for the current block is the IBC AMVP mode in a case that a smallest value in the first distortion cost set is less than a smallest value in the second distortion cost set and a distortion cost of the current block in any other prediction mode.

15. The method according to claim 14, wherein the method further comprises:
determining a first flag, wherein the first flag indicates whether the current block is allowed to use an intra block copy local illuminance compensation (IBC-LIC) mode; and
encoding the first flag.

16. The method according to claim 15, wherein the method further comprises:
determining a first index, wherein the first index indicates at least one template region for illuminance compensation; and
encoding the first index.

17. The method according to claim 14, wherein the method further comprises:
determining a second index,
wherein in a case that a value of the second index is a first value, the second index indicates that an intra block copy local illuminance compensation (IBC-LIC) mode is not used for the current block; or in a case that a value of the second index is a second value other than the first value, the second index indicates at least one template region for illuminance compensation; and
encoding the second index.

18. A decoder, comprising a processor configured to:
determine whether an intra block copy local illuminance compensation (IBC-LIC) mode is used for a current block;
in a case that it is determined that the IBC-LIC mode is used for the current block, determine at least one template region for illuminance compensation, wherein the at least one template region is used to determine a first model;
predict the current block based on an IBC mode used for the current block, to obtain a first predicted block of the current block; and
perform illuminance compensation on the first predicted block based on the first model, to obtain a second predicted block of the current block.

19. An encoder, comprising a processor configured to perform steps of the encoding method according to claim 9.

20. A computer-readable storage medium, having a computer program and a bitstream stored thereon, wherein the computer program, when executed by a processor, enables the processor to perform steps of the encoding method according to claim 9 to generate the bitstream.
